SEQUENCE LISTING (32 sequences)

SEQ ID NO: 1 - DNA, 28 bp, Artificial Sequence
  Primer
gggtaccaaatgggcagtgcctagaaga

SEQ ID NO: 2 - DNA, 30 bp, Artificial Sequence
  Primer
cccaagcttagcaaccgagaagggcactca

SEQ ID NO: 3 - DNA, 26 bp, Artificial Sequence
  Probe
actggcagcaggacgtgaccatggag

SEQ ID NO: 4 - DNA, 26 bp, Artificial Sequence
  Mutant probe
actggcagcagacaactaccatggag

SEQ ID NO: 5 - DNA, 26 bp, Artificial Sequence
  Primer
cgagctcacatgtatacatatgtaac

SEQ ID NO: 6 - DNA, 27 bp, Artificial Sequence
  Primer
ccgctcgagtgatacaagggcctgaat

SEQ ID NO: 7 - DNA, 27 bp, Artificial Sequence
  Primer
ccgctcgagcctgggaatgagtgtaca

SEQ ID NO: 8 - DNA, 25 bp, Artificial Sequence
  Primer
cccaagcttggtccagggtatgaca

SEQ ID NO: 9 - DNA, 35 bp, Artificial Sequence
  Primer
cgagtgttctccgcaactttgcacaacgatgctgc

SEQ ID NO: 10 - DNA, 37 bp, Artificial Sequence
  Primer
atcgttgtgcaaagttgcggagaacactcgtacaggc

SEQ ID NO: 11 - DNA, 59 bp, Artificial Sequence
  Synthetic oligonucleotide
tcgagaaaaaagacatagcggctggaaagatctcttgaatctttccagccgctatgtca

SEQ ID NO: 12 - DNA, 16 bp, Artificial Sequence
  Primer
gagtccgcagcaggtg

SEQ ID NO: 13 - DNA, 18 bp, Artificial Sequence
  Primer
gtgtcagagtccatggga

SEQ ID NO: 14 - protein, 18 aa, Mus musculus
EDLPSDPQDTPPRSGTEP

SEQ ID NO: 15 - DNA, 19 bp, Artificial Sequence
  ERSE consensus sequence
  misc_feature (6)..(14): n is a, c, g, or t
ccaatnnnnnnnnnccacg

SEQ ID NO: 16 - protein, 45 aa, Mus musculus
ILLCVLTFLGLSFNPLTSLLQWGGAHNTDQHPYSGSGRSVLSLES

SEQ ID NO: 17 - protein, 45 aa, Homo sapiens
ILLCVLTFLCLSFNPLTSLLQWGGAHDSDQHPHSGSGRSVLSFES

SEQ ID NO: 18 - protein, 44 aa, Mus musculus
CVMIVLAFIMLNYGPMSMLEQESRRVKPSVSPANQRRHLLEFSA

SEQ ID NO: 19 - protein, 44 aa, Homo sapiens
CVMIVLAFIILNYGPMSMLEQDSRRMNPSVGPANQRRHLLGFSA

SEQ ID NO: 20 - protein, 45 aa, Mus musculus
CVLVLVFSFCLLLVPAMYSSDARGSVPAEYVVLHRKLRALPSEDD

SEQ ID NO: 21 - protein, 45 aa, Homo sapiens
CILVLLVSFCLLLVPAMYSSDTRGSLPAEHGVLSRQLRALPSEDP

SEQ ID NO: 22 - protein, 46 aa, Mus musculus
CIAVLLLSFALIILPSISPFNSNKVDSPGDFVPVRVFSRTLHNHAA

SEQ ID NO: 23 - protein, 46 aa, Homo sapiens
CVAVLLLSFALIILPSISPFGPNKTESPGDFAPVRVFSRTLHNDAA

SEQ ID NO: 24 - DNA, 30 bp, Artificial Sequence
  Probe
atgaggaacatgacgtgtcctgtccactac

SEQ ID NO: 25 - DNA, 30 bp, Artificial Sequence
  Mutant probe
atgaggaacagtcaaggtcctgtccactac

SEQ ID NO: 26 - DNA, 17 bp, Homo sapiens
agcaggacgtgaccatg

SEQ ID NO: 27 - DNA, 17 bp, Mus musculus
gcctttacgtggctgct

SEQ ID NO: 28 - DNA, 17 bp, Mus musculus
gcattgacgggataata

SEQ ID NO: 29 - DNA, 17 bp, Homo sapiens
aacatgacgtgtcctgt

SEQ ID NO: 30 - DNA, 17 bp, Homo sapiens
gtggagacgtgttccca

SEQ ID NO: 31 - protein, 4 aa, Artificial Sequence
  ER retention signal peptide
KDEL

SEQ ID NO: 32 - protein, 4 aa, Artificial Sequence
  ER retention signal peptide
KDAS

(19) United States
(12) Patent Application Publication
(10) Pub. No.: US 2007/0111258 A1
(43) Pub. Date: May 17, 2007

(54) Compositions and methods for modulating the acute phase response

(76) Inventors: Randal J. Kaufman, Ann Arbor, MI (US); Kezhong Zhang, Ann Arbor, MI (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/471,018

(22) Filed: Jun. 20, 2006

Related U.S. Application Data
(60) Provisional application No. 60/693,190, filed on Jun. 22, 2005.
(60) Provisional application No. 60/736,665, filed on Nov. 15, 2005.

(51) Int. Cl. C40B 30/06; C40B 40/04

(52) U.S. Cl. 435/7.1

(57) ABSTRACT

Methods and compositions are provided for modulating the acute phase response. In particular, methods and compositions are provided that inhibit the acute phase response, including expression or production of C-reactive protein (CRP). The invention accordingly has applicability to the modulation of innate immune responses and to cardiovascular diseases and disorders, particularly atherosclerosis. The instant methods and compositions are based on the discovery that the mammalian transcription factor CREBH is necessary for the induction of an acute phase response and/or an innate immune response.

### RELATED APPLICATIONS

This application claims the benefit of priority to U.S. Provisional Patent Application No. 60/693,190, filed Jun. 22, 2005, and U.S. Provisional Patent Application No. 60/736,665, filed Nov. 15, 2005, which applications are hereby incorporated by reference in their entirety.

### GOVERNMENT FUNDING

Work disclosed herein was supported in part by grants received from the National Institutes of Health, namely grant numbers HL52173 and DK42394. The Government may have certain rights in the invention.

### FIELD

The present invention relates generally to methods and compositions for the treatment of mammals, including humans, with modulators of the acute phase response, and/or the innate immune response. The invention has particular relevance to the treatment and diagnosis of cardiovascular diseases and disorders, including atherosclerosis.

### BACKGROUND

Regulated intramembrane proteolysis (RIP) is the process by which transmembrane proteins are cleaved to release cytosolic domains that enter the nucleus to regulate gene transcription (Brown et al., 2000). RIP regulates two key metabolic processes: sterol and fatty acid homeostasis and stress signaling from the endoplasmic reticulum (ER) (Brown and Goldstein, 1997; Ye et al., 2000). The basic components in these systems include a distinct class of ER-localized transcription factors that contain a transmembrane domain, and proteases S1P and S2P that are located in the Golgi compartment. Specific stimuli control the activity of these transcription factors by promoting their transit to the Golgi compartment where they are cleaved by proteases S1P and S2P in a sequential manner to release the cytosolic domain that then migrates to the nucleus to stimulate transcription of specific target genes (Brown and Goldstein, 1997; Sakai et al., 1998b).

A paradigm for RIP is the processing of the sterol regulatory element binding proteins (SREBP-1, 2 and 1c), transcription factors that activate genes encoding functions that regulate the synthesis of cholesterol and fatty acids and cellular uptake of lipoproteins (Brown and Goldstein, 1997). Newly synthesized SREBP is inserted into the ER membrane via two transmembrane segments in a hairpin fashion such that both the N- and C-terminal ends of the protein project into the cytosol. When cholesterol levels in the membrane are high, SREBP is retained in the ER in a complex with the polytopic sterol-sensing transmembrane protein SCAP (SREBP cleavage-activating protein) (Matsuda et al., 2001; Sakai et al., 1998a). Cholesterol promotes interaction of SCAP with ER retention proteins called INSIGs to retain SREBP in the ER (Feramisco et al., 2005; Yang et al., 2002). When cholesterol levels decrease, the SREBP-SCAP complex dissociates from INSIG and transits to the Golgi where it is sequentially cleaved at two sites (Sakai et al., 1996). The lumenal loop between the two transmembrane domains is first cleaved by S1P to produce a membrane-anchored intermediate. The SREBP intermediate is then cleaved by S2P to release the amino (N)-terminal fragment of SREBP that traffics to the nucleus to activate transcription of genes required for sterol biosynthesis (Sakai et al., 1996). In addition, recent evidence suggests that SREBP pathway responds to sterols and functions as an oxygen sensor in fission yeast, suggesting this is an evolutionarily conserved mechanism responsive to environmental stress (Hughes et al., 2005).

Subsequently, another ER-resident transcription factor, ATF6, was identified that is regulated by RIP in response to ER stress to activate the unfolded protein response (UPR) (Haze et al., 1999; Shen et al., 2002; Ye et al., 2000b). The UPR is a translational and transcriptional program activated by the accumulation of unfolded proteins in the ER that is signaled through ER-localized transmembrane proteins including two protein kinases PERK and IRE1 and the transcription factor ATF6 (Harding et al., 2002; Kaufman, 1999; Mori, 2000; Schroder and Kaufman, 2005; Sidrauski et al., 1998). ATF6 is a type II ER transmembrane protein that contains a basic leucine zipper (bZIP) domain in the cytosol and a stress-sensing domain in the ER lumen (Haze et al., 1999). Under normal conditions, ATF6 is retained in the ER through interaction with the ER protein chaperone BiP/GRP78 (Shen et al., 2002). Upon accumulation of unfolded or misfolded proteins in the ER lumen, ATF6 is released from BiP and transits to the Golgi compartment where it is cleaved by S1P and S2P in a manner similar to that characterized for cleavage of the SREBPs (Ye et al., 2000). The ATF6 cytosolic domain generated by cleavage traffics to the nucleus to activate transcription of UPR target genes, including ER chaperones and folding enzymes (Okada et al., 2002). In addition, it was proposed that ATF6 activates transcription of X-box binding protein 1 (XBP1), a bZIP transcription factor that induces expression of many UPR target genes (Lee et al., 2002; Yoshida et al., 2001).

Recently, researchers identified several new members of the membrane-bound transcription factor family that are structurally similar to ATF6. These new members, including Luman, OASIS and CREBH, all possess a transcription activation domain, a bZIP domain in close proximity to a hydrophobic transmembrane domain, and a domain that resides in the ER lumen (Chin et al., 2005; Kondo et al., 2005; Omori et al., 2001; Raggo et al., 2002). Luman, a bZIP transcription factor similar to the herpes simplex virus transcription factor VP16, was identified as an ER-localized protein that is cleaved by the same S1P protease that cleaves SREBP and ATF6 (Raggo et al., 2002). OASIS, another ER-localized bZIP transcription factor, was recently reported to be cleaved upon ER stress in long-term cultured astrocytes (Kondo et al., 2005). OASIS modulates UPR signaling in astrocytes by inducing expression of the ER molecular chaperone BiP and by suppressing ER-stress-induced astrocyte cell death. Random sequencing of cDNA clones derived from the hepatoma cell line HepG2 identified CREBH, a CRE-like B-Box binding protein. CREBH is a hepatocyte-specific bZIP transcription factor belonging to the cyclic AMP responsive element binding protein/activating transcription factor (CREB/ATF) family (Omori et al., 2001). Recent reports suggested that CREBH requires proteolytic cleavage for its activation (Chin et al., 2005; Omori et al., 2001). However, the stimuli that activate CREBH, the mechanism of CREBH cleavage, and the physiological role that CREBH provides in the liver are unknown.

The innate immune response is an ancient metazoan adaptation mechanism initiated by chemical structures presented by invading microorganisms or revealed by damage to the host (Medzhitov and Janeway, 2002; Yoo and Desiderio, 2003). The systemic inflammatory component of innate immunity is called the acute phase response (APR). The APR is a transient deviation from homeostasis, invoked when the integrity of the organism is breached. The major APR proteins, such as C-reactive protein (CRP), bind to pathogens to mediate their elimination by activating the complement cascade and recruiting phagocytic cells (Black et al., 2004; Kushner and Kaplan, 1961). Bacterial lipopolysaccharide (LPS) triggers the APR through interaction with toll like receptor-4 expressed on monocytes, macrophages, and dendritic cells, to produce IL6, IL1β, and TNFα, which activate expression of APR genes in hepatocytes, vascular endothelium, and other target cells (Gabay and Kushner, 1999; Kadowaki et al., 2001; Medzhitov et al., 1997). Alterations in lipid metabolism that promote atherosclerosis may provide a link between chronic inflammation and cardiovascular disease (Danesh et al., 2004; Nissen et al., 2005; Ridker et al., 2005).

In view of the increasing suspicion that cardiovascular disease is linked to chronic inflammation and the innate immune response, there exists a need to better understand, and to intervene in, deleterious metabolic processes that contribute to cardiovascular disease. Thus, for example, there exists a need to modulate mediators of the acute phase response in clinical settings such as the treatment or diagnosis of atherosclerosis. Further, there exists a need for improved diagnostic and monitoring technologies that are more germane to the underlying disease producing mechanisms of atherosclerosis.

### SUMMARY

In vitro and in vivo analyses have been used to identify the molecular mechanism governing stimulus-induced activation of CREBH and its biological role. It has been found that transcription of CREBH is induced by pro-inflammatory cytokines and that ER stress activates S1P- and S2P-mediated cleavage of CREBH. CREBH plays an essential role in the innate immune response by activating transcription of genes encoding major APR proteins. A novel ER stress response pathway mediated by regulated proteolysis of CREBH that activates an inflammatory response is thus provided.

Accordingly, the invention encompasses a method of modulating an acute phase response in a mammal, comprising the step of modulating the expression of CREBH. The invention also encompasses a method of modulating an acute phase response in a mammal, comprising the step of modulating the post-translational processing of CREBH. The post-translational processing may comprise cleavage by S1P and/or S2P. In yet other embodiments, the invention encompasses a method of modulating an acute phase response in a mammal, comprising the step of modulating the association of a CREBH fragment with ATF6. In such embodiments, the CREBH fragment may be the product of cleavage of CREBH by S1P and/or S2P.

The invention further encompasses a method of modulating an innate immune response in a mammal, comprising the steps discussed above, i.e., modulating the expression and/or post-translational processing of CREBH, and/or of modulating the association of CREBH with ATF6. Similarly, the invention encompasses a method of treating inflammation-associated diseases and disorders in a mammal by these steps. In other embodiments, the invention provides a method of modulating the level of circulating C-reactive protein in a mammal by these steps. In certain embodiments, the invention provides a method of treating cardiovascular diseases and disorders, e.g. atherosclerosis in a mammal, by any of the foregoing steps.

It will be understood to those skilled in the art that the step of “modulating” may comprise inhibiting the expression and/or post-translational processing of CREBH, and/or inhibiting the association of CREBH with ATF6.

In another aspect, the invention provides methods of diagnosis and/or monitoring inflammation-associated diseases and disorders. For example, the invention provides a method of assessing whether a mammal is at risk or is likely to become at risk, for developing a cardiovascular-related disease or disorder, e.g. atherosclerosis, comprising the step of assessing the level of CREBH expression, and/or assessing the level of post-translationally modified CREBH, and/or assessing the level of a complex comprising CREBH and ATF6, in said mammal. In addition, the invention provides a method of monitoring treatment of a mammal for a cardiovascular-related disease or disorder, e.g. atherosclerosis, comprising the step of assessing the level of CREBH expression, and/or assessing the level of post-translationally modified CREBH, and/or assessing the level of a complex comprising CREBH and ATF6, in said mammal.

In still another aspect, the invention provides a method of identifying compounds that modulate an acute phase response in a mammal, comprising the steps of: (a) providing a mammalian cell capable of expressing CREBH; (b) exposing said cell to an inducer of the acute phase response; (c) contacting said cell with a candidate compound; and (d) assessing whether CREBH expression in said cell is modulated by exposure to the inducer in the presence of the candidate compound, relative to the expression level thereof in the absence of the candidate compound; wherein modulation of the expression level of CREBH in the presence of the candidate compound indicates that the compound is a modulator of the acute phase response in said mammal. The invention also provides similar methods wherein, in lieu of assessing modulations of CREBH expression, modulations in post-translational processing of CREBH are assessed. Additional methods of the present invention assess modulations in the formation of a complex between CREBH and ATF6. In each case, the methods may include steps (a)-(d) above. In each of the foregoing methods, the inducer of the acute phase response may be, as desired, a pro-inflammatory cytokine, a drug that induces ER stress, or bacterial LPS. Further, the CREBH used in the method may be a fusion protein. For example, the CREBH may be fused to a detectable peptide, such as the flag peptide.

The foregoing methods are applicable to the testing of numerous diverse types of candidate compounds. In some embodiments, the candidate compound is a small molecule, e.g. a member of a combinational chemistry library. Alternatively, it may be a member of a natural product library.

In other aspects, the invention provides diverse compounds suitable for use in the foregoing methods. For example, the invention encompasses compounds identified according to the screening methods summarized above. In addition, the invention provides compounds that inhibit expression of CREBH in a mammalian cell. By way of example, such a compound may be a small interfering RNA (siRNA). The invention accordingly provides a vector comprising a sequence encoding the siRNA. In other embodiments, compounds are provided that inhibit post-translational processing of CREBH in a mammalian cell; by inhibiting cleavage of CREBH by S1P and/or S2P. In yet other embodiments, the invention provides compounds that inhibit formation of a complex between CREBH and ATF6 in a mammalian cell, by binding to CREBH, or alternatively to ATF6. In each case, the compound is preferably a small molecule, or is otherwise capable of permeating the mammalian cell membrane, or in the case of siRNA, is produced intracellularly.

The invention still further provides nucleic acid and polypeptide compounds suitable for use in the methods disclosed herein. By way of example, the invention provides a dominant negative CREBH polypeptide, consisting of a CREBH bZIP domain. It will be appreciated that the instant dominant negative polypeptide can include less than all of the bZIP domain, or more than all of the bZIP domain, as long as the polypeptide is capable of associating with ATF6 and does not transcriptionally activate CREBH target genes. The instant polypeptide is produced intracellularly, using a vector encoding the dominant negative CREBH polypeptide. The vector accordingly is encompassed by the present invention, as are gene therapy techniques for delivering the vector into mammalian cells, whether disposed in vivo or ex vivo.

The invention provides still further additional types of compounds that inhibit or interfere with the biological activities of CREBH. For example, the invention encompasses a compound that inhibits the binding of CREBH to nucleic acid comprising an UPRE, thereby downmodulating expression of genes under the control of the UPRE. Such a compound can bind to CREBH at the site where it interacts with the UPRE nucleic acid sequence, or conversely it can bind to the UPRE nucleic acid sequence itself. Still further, the invention provides a compound that inhibits the binding of CREBH to nucleic acid encoding a 5′ flanking sequence of the human CRP gene. Such a compound may bind to CREBH at the site where it interacts with the instant 5′ flanking sequence, or it may bind to said 5′ flanking sequence itself.

### BRIEF DESCRIPTION OF THE DRAWINGS

FIG. 1 depicts the induction of expression of CREBH during fetal liver development and by proinflammatory cytokines. (A) Structural comparison of CREBH and ATF6. The domains are indicated by residue numbers of amino acids. (B) Northern blot analysis of CREBH mRNA levels in various tissues from mice. Tissue samples were collected from 3-month-old wild-type C57BL/6J mice. Levels of β-actin mRNA were determined for control of sample loading. (C) Expression profile of CREBH mRNA in fetal livers during embryogenesis. (D) Induction of CREBH mRNA in murine hepatoma cell line H2.35 under IL6 (40 ng/ml) stimulation for various time points. For panels A-D, experiments were performed at least 3 times and representative data are shown.

FIG. 2 depicts the analysis of gene expression in H2.35 cells. H2.35 cells were treated with 20 ng/ml TNFα, 40 ng/ml IL1β, 20 μg.ml LPS, 5 mM DTT, 0.5 μM Tg, 5 μg/ml Tm or 0.5 μg/ml BFA for 4, 8 and 12 hours, respectively. Levels of CREBH mRNA (A) and spliced XBP1 mRNA (B) in H2.35 were determined by quantitative real-time RT-PCR. Fold changes of mRNA induction were determined after normalization of the mRNA levels to internal control 18S ribosomal RNA levels. Note that established hepatocyte cell lines, such as H2.35 and HepG2, do not express sufficient levels of endogenous SAP and CRP proteins to permit analysis of APR activation in response to inflammatory cytokines. However, expression from the SAP or CRP promoter-reporter plasmids is sufficiently measurable in H2.35 cells so that it is possible to investigate transcriptional activation effects of CREBH on the CRP and SAP promoters by reporter assays in H2.35 cells. These reporter experiments are not possible in non-hepatocyte cell lines. However, for non-hepatocyte cell lines, such as wild-type and mutant CHO cells, CREBH cleavage and activation could be measured using the UPRE reporter assay. (C) Summary of stimuli that induce CREBH mRNA, NF-κB activation and the UPR in H2.35 and HepG2 cells. (D) Expression of BiP and GRP94 in H2.35 cells over-expressing CREBH or ATF6. H2.35 cells in a 35 mm collagen-coated plate were transfected with 1.5 μg empty DNA vector, vector expressing the nuclear form of CREBH (CREBH-N) or vector expressing nuclear form of ATF6 (ATF6 p50), respectively. Expression levels of BiP and GRP 94 were determined by Western blot analysis by using a murine and —BiP monoclonal antibody and a murine anti-GRP94 monoclonal antibody, respectively. The membranes were re-blotted with an anti-α-actin antibody for control of sample loading.

FIG. 3 depicts the effects of ER stress on CREBH: proteolytic cleavage of CREBH to release its N-terminal fragment that translocates into the nucleus. (A) Illustration of transmembrane domains and lumenal domains of SREBP, ATF6, Luman and CREBH in human (hs), mouse (mm). The conserved residues for S1P and S2P recognition are highlighted. (B) Cleavage of CREBH in H2.35 cells under different stimuli. H2.35 cells stably expressing flag-tagged human CREBH were treated with 0.5 μg/ml BFA, 20 ng/ml TNFα, 40 ng/ml IL6, 5 mM DTT, 0.5 μM Tg or 5 μg/ml Tm for 8 hours. Untransfected H2.35 cells (lane 1) and the H2.35 cells that stably express human CREBH (lane 2) were cultured under normal conditions as control. Total cell lysates were collected for Western blot analysis by using an anti-flag monoclonal antibody (upper panel). Levels of α-actin were determined for control of protein loading (lower panel). (C) Cleavage of CREBH in H2.35 cells under Tm treatment for various time periods. The H2.35 cells stably expressing flag-tagged CREBH were cultured in the absence or presence of Tm (5 μg/ml) for 4, 8 or 12 hours. Membrane fractions were isolated from the total cell lysates, and were subjected to Western blot analysis of CREBH and calnexin, respectively. Nuclear fractions were isolated from the same total cell lysates and subjected to Western blot analysis of CREBH and PARP, respectively. (D) Translocation of CREBH in COS7 cells. COS7 cells were co-transfected with a construct expressing flag-tagged full-length CREBH (CREBH-F) or CREBH-ΔC and a construct expressing KDEL-RFP, and were then cultured in the absence or presence of Tm (5 μg/ml) for 4 hours. Cells were then stained with FITC-conjugated anti-flag antibody and subjected to Zeiss Confocal Microscope analysis. Magnification: 40×10.

FIG. 4 depicts gene chip micorarray analysis of fetal livers from the CREBH knockdown or control RNAi embryos. The table lists the genes whose expression levels are lower or higher in the CREBH knockdown mice than those of the control mice (P≦0.001), n=3 CREBH knockdown or 3 control RNAi fetal livers, S.D. is indicated. The expression value and fold changes were represented in log 2 algorithm. Fold changes were calculated as the CREBH knockdown samples versus the control samples.

FIG. 5 depicts the cleavage of CREBH by proteases S1P and S2P upon ER stress. (A) CREBH is cleaved by S1P-KDEL, but not S1P-KDAS. COS7 cells were co-transfected with a construct expressing flag-tagged full-length CREBH and a construct expressing S1P-KDAS or S1P-KDEL. CREBH construct DNA (1 μg) was mixed with S1P-KDEL or S1P-KDAS construct DNA (1 or 2 μg as indicated) for transfection of cells in one well of a 6-well plate. COS7 cells expressing full-length CREBH were also cultured in the absence or presence of 0.5 μM BFA for 8 hours. COS7 cells expressing CREBH-ΔC, the cytosolic/nuclear form of CREBH, were included as a positive control. Expression and cleavage of CREBH were detected by Western blot analysis using an anti-flag antibody. (B) Cleavage of CREBH in wild-type (K1), S2P-deficient (M19), and S2P-deficient (SRD-12B) CHO cells. Cells were transfected with construct DNA expressing flag-tagged-full-length CREBH (0.3 ug DNA/well of 6-well plate) and were cultured in the absence or presence of Tm (5 μg/ml) for 10 hours. To rescue the defect of S1P- or S2P-deficient cells, DNA constructs expressing S1P or S2P were co-transfected with the full-length CREBH construct into S1P- or S2P-deficient cells. Membrane and nuclear fractions were isolated from total cell lysates and subjected to Western blot analysis using an anti-flag antibody. (C) Cleavage of CREBH mutant R361A. COS7 cells were transfected with construct expressing flag-tagged wild-type CREBH or mutant CREBH (R361A), and were cultured in the absence or presence of Tm. Membrane and nuclear fractions were isolated from total cell lysates and subjected to Western blot analysis. (D) Luciferase reporter analysis of trans-activation effects of CREBH or ATF6 on the ERSE motif. COS7 cells in one well of 6-well plate were co-transfected with the CREBH or ATF6 expression vector (0.2 μg), an ERSE-luciferase reporter construct (0.5 μg), and pcDNA3-lacZ (0.2 μg), and were then cultured in the absence or presence of Tm (5 μg/ml) for 810 hours. The amount of luciferase activity was normalized to the amount of β-galactosidase activity to correct for transfection efficiency in each experiment. Each bar denotes the mean±S.D. (E) Luciferase reporter analysis of trans-activation effects of CREBH or ATF6 on the UPRE motif. COS7 cells in one well of 6-well plate were co-transfected with the CREBH or ATF6 expression vector (0.2 μg), a UPRE-luciferase reporter construct (0.5 μg), and pcDNA3-lacZ (0.2 μg), and were then cultured in the absence or presence of Tm for 10 hours. (F) Luciferase reporter analysis of trans-activation effects of CREBH on the UPRE reporter in wild-type (K1), S1P-deficient (SRD-12B), and S2P-deficient (M19) CHO cells. Cells in one well of 6-well plate were co-transfected with a construct expressing full-length CREBH (CREBH-F) or nuclear/cleaved form of CREBH (CREBH-N) (0.2 μg), luciferase reporter construct (0.5 μg), and pcDNA3-lacZ (0.2 μg), and were then cultured in the absence or presence of Tm for 10 hours.

FIG. 6 depicts verification of induction of APR genes in the CREBH knockdown and the control RNAi fetal livers by using quantitative real-time RT-PCR. The method for quantitative real-time RT-PCR is described in the Experimental Procedures section. Four CREBH knockdown or 4 RNAi control fetal liver samples were analyzed. Each bar denotes the mean±S.D.

FIG. 7 depicts the requirement of CREBH to up-regulate the acute phase response genes CRP and SAP. (A) Identification of CREBH knockdown mice by Northern blot analysis. Transgenic mice with empty vector lentivirus expressing GFP were used as controls. Total RNAs (15 μg/lane) were isolated from the livers of the CREBH RNAi or the control mice, and subjected to Northern blot analysis. A 260 bp GFP cDNA fragment and a 210 bp mouse CREBH cDNA fragment were used as probes for detecting levels of GFP mRNA and CREBH mRNA, respectively. Levels of ββ-actin mRNA were determined for control of sample loading. (B) Morphology of CREBH knockdown embryos. The embryos were collected at gestation stage E14.5. The paraffin-embedded embryo sections were stained with hematoxylin and eosin. Magnification: 20 X. (C) Northern blot analysis of levels of CREBH, CRP and SAP mRNA in the livers of the CREBH knockdown or the control mice. Levels of β-actin mRNA were determined for sample loading controls. (D-E) Serum levels of SAP and CRP in the CREBH knockdown and the siRNA control mice in response to IL6 plus IL1β LPS or Tm. CREBH knockdown and RNAi control mice at 3-months of age were challenged with recombinant mouse IL6 (25 ng/gram body weight) plus recombinant mouse IL1β (25 ng/gram body weight), LPS (3 μg/gram body weight) or Tm (2 mg/kg body weight). Serum levels of SAP and CRP in the mice were determined before injection and at 24 hours after IL6 plus IL1β, LPS or Tm injection. Data points are serum levels of SAP or CRP for individuals, n=5 CREBH knockdown or 5 control RNAi mice per injection. The differences in CREBH knockdown and control mice are statistically significant (P<0.001). CTL, control RNAi mice; KD, CREBH knockdown mice.

FIG. 8 depicts the induction of unfolded protein response genes. (A) Induction of CRP, SAP, BiP and spliced XBP1 mRNAs in hemophilia A factor VIII-deficient mice that express a B domain-deleted clotting factor VIII. Previous studies demonstrated that secretion of human clotting factor VIII is inefficient, because factor VIII interacts with BiP and induces an ER stress response (Dorner et al. 1987; Dorner et al. 1989). Although deletion of the factor VIII B domain increases expression of a functional protein, it does not improve secretion efficiency, thus causing accumulation of unfolded or misfolded FVIII protein in the ER (Miao et al. 2004). To study the effect of factor VIII expression in hepatocytes in vivo, factor VIII-deficient mice (Bi et al. 1995) at 3 months of age were analyzed after hydrodynamic plasmid DNA tail vein injection with a vector designed to express B domain-deleted factor VIII protein or the empty vector that expresses dihydrofolate reductase, a cytosolic protein, as previously described (Miao et al. 2004). Liver samples were collected from mice at 24 hours injection. At 24 hours post-injection the circulating levels of factor VIII in the plasma were approximately 2.4 units/ml determined by a commercial factor VIII activity assay (COAMATIC, DiaPharma, West Chester, Ohio) (Miao et al. 2004). One unit of factor VIII activity is that amount present in one ml of normal pooled human plasma (approximately 150 ng/ml). Liver tissues were obtained at 24 hours post-injection for RNA analysis. Experiments were performed at least 3 times and representatives data are shown. (B) Induction of the BiP, CHOP, EDEM, and spliced XBP1 mRNAs in H2.35 cells challenged with IL6 plus IL1β. H2.35 cells were treated with 40 ng/ml IL6 plus 40 ng/ml IL1β for 0.5, 1, 3, 6 and 8 hours, respectively. Levels of BiP, CHOP, EDEM, and spliced XBP1 mRNAs in H2.35 were determined by quantitative real-time RT-PCR. Data points denote the mean±S.D. (C) Northern blot analysis of the SAP and CRP mRNA levels in mouse liver, H2.35 and HepG2 cells in the presence or absence of pro-inflammatory cytokines. Wild-type C57B1/6J mice of 3-month old were intraperitoneally injected with IL6 (25 ng/gram body weight) plus IL1β (25 ng/gram body weight). Mice were injected with the same volume of NaCL solution as controls. Liver total RNA was prepared at 24 hours after injection. H2.35 and HepG2 cells were treated with 40 ng/ml IL6 plus 40 ng/ml IL1β for 8 hours. Total RNA was prepared from the treated and untreated cells for Northern blot analysis. Levels of B-actin mRNA were determined for controls.

FIG. 9 depicts the activation, by ER stress of both the UPR and the APR, in hepatocytes. FIG. 9 further depicts the induction of ER stress by inflammatory cytokines. (A) Induction of CRP, SAP, BiP and spliced XBP1 mRNAs in mouse primary hepatocytes in response to Tm treatment. Primary hepatocytes were isolated from fetal livers of C57BL/6J mice at embryonic stage E18, and were then treated with Tm (5 μg/ml) for 2, 4, 6, and 8 hours. Total RNA was isolated and subjected to Northern blot analysis to determine levels of CRP, SAP and BiP mRNAs (upper panel). Levels of spliced XBP1 mRNA were determined by quantitative real-time RT-PCR (lower panel). For panels A-B, experiments were performed at least 3 times and representative data are shown. (B) Induction of CRP, SAP, BiP and spliced XBP1 mRNAs in mice injected with Tm. C57BU6J mice at 3-months of age were injected intraperitoneally with Tm (2 mg/kg body weight) in 150 mM dextrose solution. Mice were injected with the same volume of dextrose solution as a control. Liver tissues were collected from mice at 24 hours after injection for RNA isolation. (C-E) Induction of the BiP, CHOP, EDEM, spliced XBP1, SAP and CRP mRNAs in mice challenged with IL6, IL1β, LPS or Tm. Wild-type C57B1/6J mice at 3-months of age were intraperitoneally injected with recombinant murine IL6 (25 ng/gram body weight), recombinant murine IL1β (25 ng/gram body weight), LPS (3 μg/gram body weight) or Tm (2 μg/gram body weight). Mice were injected with the same volume of NaCL (for panels C and D) or dextrose (for panels E) solution as controls. At 24 hours after injection, liver samples were collected for isolating total RNA. Quantitative real-time RT-PCR was used to determine the mRNA levels. Fold changes of mRNA induction were determined after normalization of the mRNA levels to internal control 18S ribosomal RNA levels. Each bar denotes the mean±S.D., n=5 mice per injection. Fold of increase in mRNA levels upon each stimuli and difference between those stimuli are statistically significant (P<0.001). (F-G) Expression of endogenous CREBH protein in the livers of wild-type (F) and CREBH knockdown (G) mice challenged with IL6 plus IL1β, LPS or Tm. Wild-type or CREBH knockdown mice of 3-month old were intraperitoneally injected with IL6 (25 ng/gram body weight) plus IL1β (25 ng/gram body weight), LPS (3 μg/gram body weight) or Tm (2 μg/gram body weight). Mice were injected with the same volume of NaCL solution as controls. Liver protein extracts were prepared at 24 hours after injection. Western blot analysis was performed by using a polyclonal anti-mouse CREBH antibody. The blots were reprobed with anti-α-actin antibody for loading controls.

FIG. 10 depicts activation of expression of APR genes in vivo. (A) The nuclear form of CREBH or ATF6 activates expression of the endogenous SAP mRNA in mice. Northern blot analysis of the endogenous SAP mRNA in mice injected with vector expressing the nuclear form of ATF6 (ATF6 p50) or CREBH (CREBH-N). Wild-type C57BL/6J mice at 3 months of age were injected with 80 μg plasmid DNA expressing ATF6 p50, CREBH-N or empty vector DNA through hydrodynamic plasmid DNA tail-vein injection (Miao et al. 2004). Liver samples were collected from mice at 36 hours after injection, and were subjected to Northern blot analysis to detect the murine SAP mRNA levels. Experiments were performed at least 3 times and representative data is shown. (B-C) Nuclear forms of CREBH and ATF6 act synergistically to induce transcription from the human CRP promoter and the UPRE motif. To detect synergistic effects of CREBH and ATF6 on expression of the reporter, vector DNA (15 ng control vector, 10 ng CREBH- and/or 15 ng AFT6-expression vector) was mixed with 100 ng reporter construct and 150 ng pcDNA3-lacZ for transfection of H2.35 cells in one well of a 6-well plate. The amount of luciferase activity was normalized to the amount of β-galactosidase activity.

FIG. 11 depicts the synergistic interaction of CREBH with ATF6 to activate transcription of the major APR genes. (A) Luciferase reporter analysis of trans-activation effects of CREBH on promoters of the murine SAP gene and the human CRP gene in H2.35 cells. H2.35 cells in a 35 mm collagen-coated plate were co-transfected with a control vector or a CREBH expression vector (0.25 μg), the luciferase reporter (0.6 μg) and pcDNA3-LacZ (0.25 μg), and were then cultured in the absence or presence of Tm (5 μg/ml) for 10 hours. (B) CREBH-DN efficiently suppresses CREBH trans-activation on the murine SAP and the human CRP promoters. H2.35 cells were co-transfected with the luciferase reporter construct and a control vector or a vector expressing CREBH-DN, and were then cultured in the absence or presence of Tm (5 μg/ml) for 10 hours. (C) Interaction between ATF6 and CREBH was determined by IP-Western blot analysis. 293T cells were transfected with a control vector or a vector expressing the nuclear/cleaved form of CREBH, and were then cultured in the absence or presence of Tm for 8 hours. Total cell lysates were immunoprecipated by using an anti-human ATF6 polyclonal antibody or an anti-flag antibody and were then subjected to Western blot analysis by using anti-flag antibody or anti-human ATF6 antibody. Expression levels of CREBH in the transfected cells were determined by Western blot analysis of total cell lysates using the anti-flag antibody (lower panel). (D) Luciferase reporter analysis showing trans-activation effects of the nuclear forms of ATF6 or CREBH on the murine SAP and human CRP promoters in H2.35 cells. H2.35 cells in a 35 mm collagen-coated plate were co-transfected with a vector expressing ATF6 p50 or CREBH-N (0.25 μg), the luciferase reporter (0.6 μg) and pcDNA3-LacZ (0.25 μg). (E-F) Luciferase reporter analysis showing synergistic effects of CREBH and ATF6 on transcriptional induction from the murine SAP promoter (E), and the human CRP promoter (F) in H2.35 cells. To detect synergistic effects of CREBH and ATF6 on reporter gene expression, vector DNA (25 ng control vector, 20 ng CREBH- and/or 25 ng ATF6-expression vector) was mixed with 100 ng reporter construct and 150 ng pcDNA3-lacZ for transfection of H2.35 cells in a 35 mm collagen-coated plate.

FIG. 12 depicts binding activities of various forms of CREBH. (A) EMSA analysis of binding activities of full-length and the nuclear-cleaved forms of CREBH to the CREBH/ATF6-binding elements. Membrane protein fractions and nuclear protein extracts were prepared from the transfected COS1 cells over-expressing flag-tagged full-length or nuclear/cleaved forms of CREBH. Control, COS1 cells transfected with vector control; CREBH-F, transfected COS1 cells over-expressing full-length CREBH; CREBH-N, transfected COS1 cells over-expressing nuclear/cleaved form of CREBH; Tm, tunicamycin treatment; B-oligo, biotin-labeled human CRP DNA probe; Pr, protein fraction/extract; ME, membrane protein fraction from the transfected COS1 cells; NE, nuclear extract from the transfected COS1 cells, (B) Western blot analysis to detect expression levels of the full-length and the nuclear/cleaved forms of CREBH in the membrane fractions and the nuclear extracts used for EMSA analysis in panel A. Western blot analysis confirmed that the full-length CREBH was abundantly expressed in the membrane protein fractions from the COS1 cells over-expressing full-length CREBH and that the nuclear/cleaved form of CREBH was expressed in the nuclear protein extracts. (C) CREBH activates expression of luciferase under control of the human ApoB gene promoter in H2.35 cells. A 901 bp 5′-promoter region from the human AopB gene was amplified from human genomic DNA by using primers 5′-GGGTACCAAATGGGC AGTGCCTAGAAGA-3′ and 5′-CCCAAGCTTAGCAACCGAGAAGGGCACTCA-3′. The amplified DNA fragment was digested with Kpn1 and HindIII, and then inserted into luciferase reporter vector pGL3-basic (Promega, Madison, Wis.) between Kpn1 and HindIII. H2.35 cells in a 35 mm collage-coated plate were transfected with control vector DNA or vector DNA expressing ATF6 p50 or CREBH-N (0.25 μg), human ApoB reporter (0.5 μg) and pcDNA3-lacZ (0.25 μg). The amount of luciferase activity was normalized to the amount of β-galactosidase activity to correct for transfection efficiency in each experiment. Each bar denotes the mean±S.D. (D) EMSA analysis of binding activity of CREBH or ATF6 to the human ApoB promoter element. B-oligo, biotin-labeled ApoB DNA probe; M-oligo, biotin-labeled mutant probe; “CTL” represents NE from COS1 cells transfected with empty vector; “C” represents NE from COS1 cells expressing CREBH-N; “A” represents NE from COS1 cells expressing ATF6 p50. The sequences of DNA probe used for EMSA are indicated. (E) Murine endogenous ApoB mRNA slightly increases in response to ER Stress. C57BL/6J mice at 3-months of age were injected intraperitoneally with Tm (2 μg/gram body weight) in 150 mM dextrose solution. Mice were injected with the same volume of dextrose solution as a control. Liver tissue were collected from mice at 24 hours after injection for RNA isolation. Quantitative real-time RT-PCR was used to determine the ApoB and the spliced XBP1 mRNA levels. Fold changes of mRNA induction were determined after normalization of the mRNA levels to internal control 18S ribosomal RNA levels. Data points are fold changes of the ApoB or spliced XBP1 mRNA levels for individuals, n=5 mice per injection.

FIG. 13 depicts the binding of CREBH and ATF6 to conserved DNA sequence motifs identified in APR genes. (A) The proposed CREBH/ATF6-binding elements present in the human CRP, murine SAP, human ApoB and murine ApoB genes. (B) CREBH preferentially binds to the proposed CREBH/ATF6-binding element in the promoter region of the human CRP gene. EMSA was performed using 20 μg NE from COS1 cells transfected with empty vector or vector expressing CREBH-F or CREBH-N and 100 fmol biotin-labeled DNA probe. The sequence of human CRP probe used for EMSA is 5′-ACTGGCAGCAGGACGTGACCATGGAG-3′; the mutant probe is 5′-ACTGGCAGCAGACAACTACCATGGAG-3′. B-oligo, biotin-labeled DNA probe; N-oligo, non-labeled probe; M-oligo, biotin-labeled mutant probe; “CTL” represents NE from COS1 cells transfected with empty vector; “F” represents NE from COS1 cells expressing CREBH-F; “N” represents NE from COS1 cells expressing CREBH-N. (C) DNA-protein binding assay shows that CREBH and ATF6 specifically bind to the same element from the human CRP gene. NE protein (600 μg) from transfected COS1 cells expressing flag-tagged CREBH-N and/or HA-tagged ATF6 p50 and 6 μg biotin-labeled DNA probe were used for this analysis. The upper panel shows detection of CREBH bound to the probe by using an anti-flag antibody. NE from COS1 cells expressing CREBH-N was subjected to normal Western blot analysis as a positive control (lane 1). The lower panel shows detection of ATF6 bound to the probe by using an anti-HA antibody. NE from COS1 cells expressing ATF6 p50 was subjected to normal Western blot analysis as a positive control (lane 9). B-oligo, biotin-labeled DNA probe; M-oligo, biotin-labeled mutant probe; “CTL” represents NE from COS1 cells transfected with empty vector; “C” represents NE from COS1 cells expressing CREBH-N; “A” represents NE from COS1 cells expressing ATF6 p50; “C+A” represents NE from COS1 cells expressing both CREBH-N and ATF6 p50. (D) Proposed model for CREBH-mediated signaling pathway.

### DETAILED DESCRIPTION

Regulated trafficking and intramembrane proteolysis of a unique class of endoplasmic reticulum (ER) membrane-anchored transcription factors, SREBP and ATF6, represents a mechanistic paradigm to maintain sterol homeostasis and mediate the unfolded protein response (UPR), respectively. CREBH has herein been identified as a new member of this class of factors that is cleaved upon ER stress to activate the acute phase response. CREBH is a liver-specific basic leucine zipper (bZIP) transcription factor of the CREB/ATF family with a transmembrane domain that allows it to localize to the ER. Pro-inflammatory cytokines IL6, IL-1β and TNFα increase transcription of membrane-anchored CREBH. Upon ER stress, CREBH is cleaved by Golgi-resident proteases S1P and S2P to liberate an amino-terminal cytosolic fragment that transits to the nucleus. Knockdown of the CREBH gene in the mouse revealed that CREBH is not required for liver development but is required to activate transcription of major acute phase response genes encoding serum amyloid P-component (SAP) and C-reactive protein (CRP) in response to ER stress. Furthermore, CREBH and ATF6 can bind to a promoter element in specific acute phase responsive genes and synergistically induce transcription of the human CRP gene and the murine SAP gene upon ER stress in hepatocytes. Finally, pro-inflammatory cytokines IL6 and IL1β activate the UPR and induce cleavage of CREBH in the liver in vivo. Provided herein is a molecular mechanism for activation of a novel ER-localized transcription factor CREBH that is essential for transcriptional induction of innate immune response genes, and reveal an unprecedented link by which ER stress initiates an acute inflammatory response.

Abbreviations used herein have the following art-recognized meanings: RIP, regulated intramembrane proteolysis; CREB, cyclic AMP-responsive element-binding protein; ER, endoplasmic reticulum; UPR, unfolded protein response; b-ZiP, basic lucine zipper protein; SREBP, sterol regulatory element binding protein; ATF, activating transcription factor; APR, acute phase response; CRP, C-reactive protein; SAP, serum amyloid P-component.

All terms used herein are intended and should be understood to have their ordinary meaning in the art. For the sake of clarity, and not by way of limitation, selected terms are defined as follows:

The terms “modulating” “modulate” or “modulation” refer to an increase or decrease in a detectable parameter, such as a level of gene expression and/or protein production or processing, and/or protein-protein complex formation. In many embodiments of the present invention, the desired modulation is an inhibition of the level of gene expression, protein production, protein processing, and/or protein-protein complex formation.

The term “mammal” includes any animal classified phylogenetically as a mammal, but preferably includes primates, such as apes, and particularly preferably includes humans. Other animals within the term “mammal” include companion animals such as dog, cat, and ferret; farm animals such as cows, pigs, sheep and goats; sport or zoo animals such as horses, dogs, lions, tigers, and bears, and endangered, threatened, or heirloom varieties of any of the foregoing.

The term “inflammation” refers to a localized or systemic protective response elicited by injury or destruction of tissue. If localized, inflammation serves to destroy, dilute, or wall off both the injurious agent and the injured tissue.

The terms “cardiovascular disease” and “cardiovascular disorder” are used interchangeably herein and refer to disorders, which are generally systemic, that adversely affect the mammalian circulating system, including both the heart and vasculature (the latter including both blood vessels and lymphatic vessels). Such disorders may be associated with an underlying metabolic disorder, such as diabetes, or may primarily affect the cardiovascular system. The disorders may be chronic or acute. Non limiting examples include atherosclerosis, hypertension, cardiac hypertrophy, heart failure such as congestive heart failure, myocarditis, vasculitis, arthritis, anevisms, myocardial infarction, angina, stroke, pulmonary embolism, peripheral vascular disease such as Raynaud's disease, claudication, thrombophlebitis, lymphangitis, and lymphedema.

The term “atherosclerosis” refers to the progressive narrowing and hardening of the arteries in a mammal, and as such is a common type of cardiovascular disease. Atherosclerosis is associated with an increased incidence of hypertension, cardiac hypertrophy, myocardial infarction, congestive heart failure, stroke, and peripheral vascular disease.

The term “small molecule” refers generally to any molecule having a molecular weight of less than about 500 daltons. Preferred small molecules are pharmaceutical small molecules, e.g., peptides, peptide analogs or derivatives, or non-peptide carbon based molecules such as those found in the U.S. Pharmacopoeia (see, e.g., protease inhibitors). Novel and/or previously uncharacterized small molecules may be found in libraries of compounds derived via combinatorial chemistry, or from natural product sources.

The term “fusion protein” refers to a polypeptide comprising two or more independently derived polypeptide sequences that do not coexist as a single entity in nature. Thus, a fusion protein comprises a first polypeptide that is linked through a peptide bond to a second polypeptide. Either the first or the second polypeptide may be all or part of a synthetic or naturally-derived sequence that confers detectability, stability, dimerization or multimerization promoting properties, or solubility. Thus, for example, a CREBH polypeptide may be linked to a detectable peptide epitope, such as flag, or a detectable polypeptide, such as green fluorescent protein. It is preferred that fusion proteins are made via conventional genetic engineering techniques.

The term “small interfering RNA” or “siRNA” refers to an RNA oligonucleotide about 22 bases in length, that is capable of producing RNA interference, known as “RNAi,” through natural mechanisms in a mammalian cell. Exemplary methodology for producing and using siRNAs is disclosed in WO 2005/014782, the teachings of which are incorporated herein by reference.

A “dominant negative” polypeptide is a mutant, synthetic, or recombinant truncated version of a natural polypeptide, which competitively inhibits the action of the corresponding natural polypeptide. Thus, for example, where the natural polypeptide is active as a homodimer or a heterodimer with another polypeptide, the dominant negative form replaces the natural form, but lacks one or more functional capacities of the natural form.

The host cells, vectors and DNA constructs useful in the present invention may be produced using routine genetic engineering techniques. Exemplary methods for production thereof are disclosed in U.S. Pat. No. 6,322,962, the teachings of which are incorporated by reference.

Molecular mechanisms governing stimulus-induced activation of a novel bZIP transcription factor, CREBH, and its physiological functions are provided. CREBH plays a central role in activation of the innate immune response as supported by the following: (1) expression of CREBH is liver specific and is induced by pro-inflammatory cytokines; (2) ER stress induces cleavage of CREBH to release an N-terminal fragment that traffics to the nucleus to activate transcription; (3) CREBH activation requires processing by Golgi-localized proteases S1P and S2P; (4) CREBH is required for the APR by regulating transcription of the CRP and SAP genes; (5) CREBH and ATF6 bind to a conserved promoter element in the specific APR gene; (6) CREBH and ATF6 interact and synergistically activate transcription of target genes in hepatocytes upon ER stress; and (7) pro-inflammatory cytokines induce cleavage of CREBH and activate the APR and the UPR in the live in vivo. A previously unrecognized connection between intracellular stress and activation of an organismal inflammatory response is thus presented by the present invention.

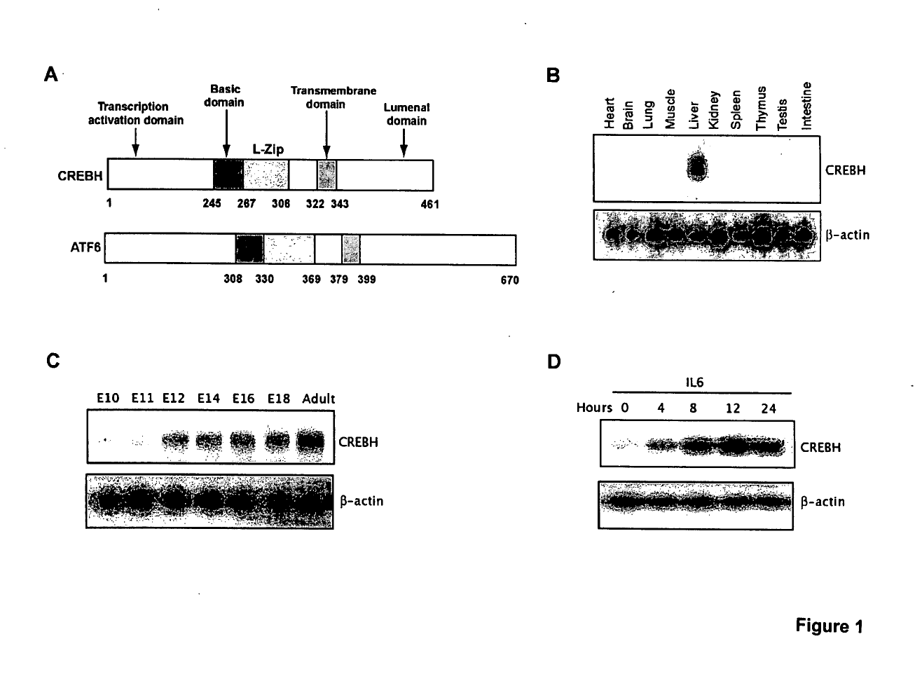

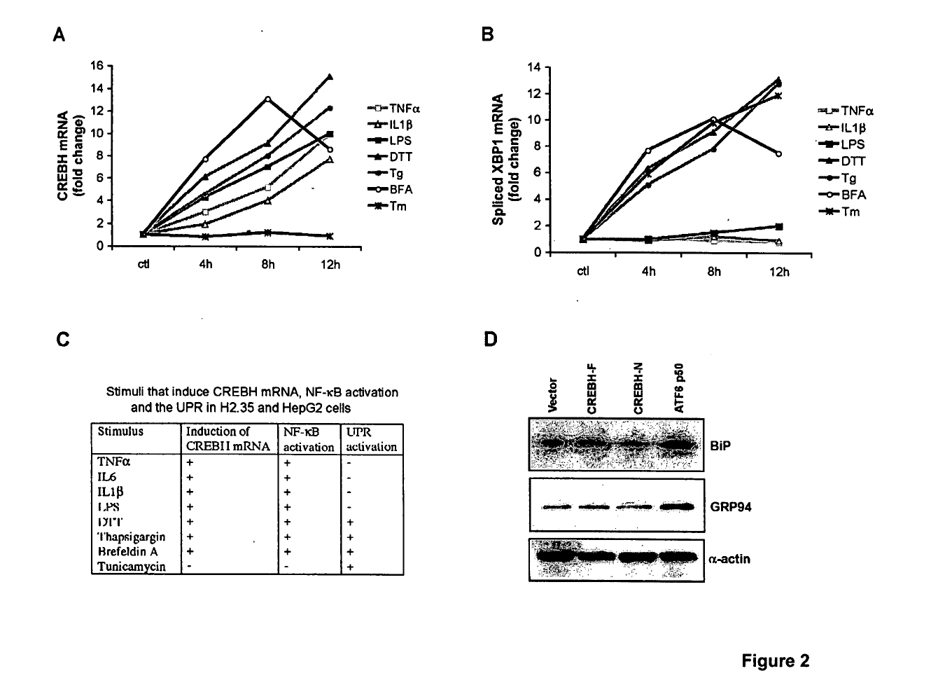

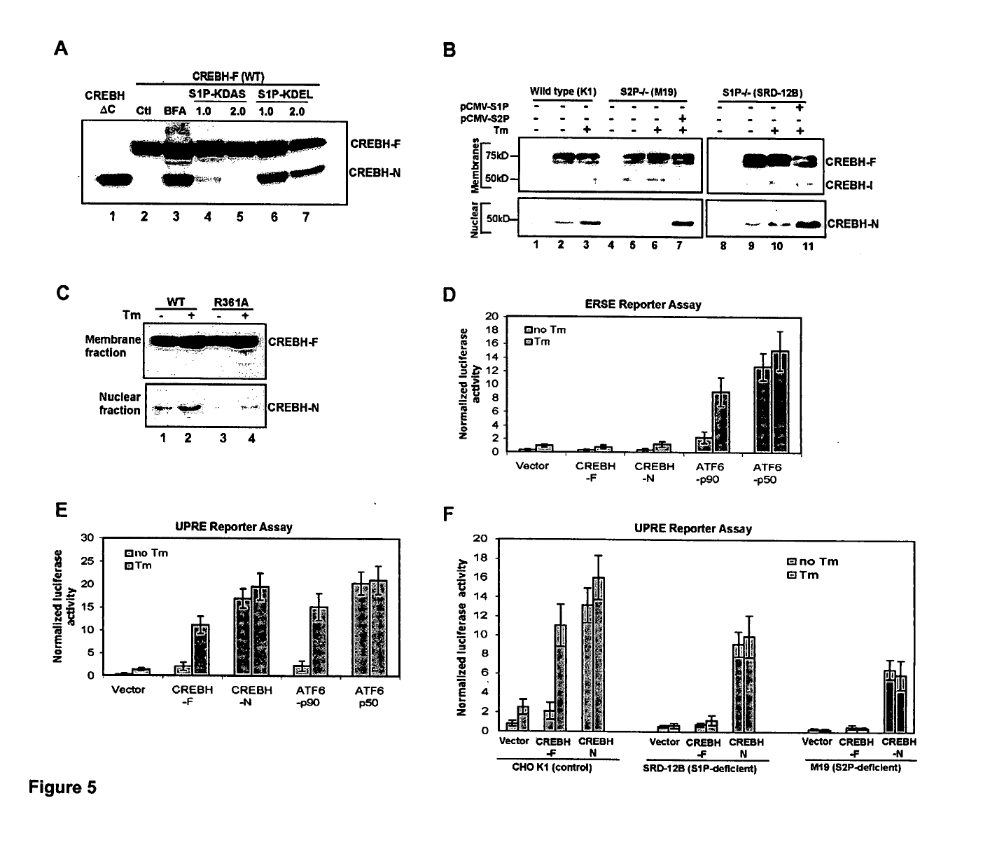

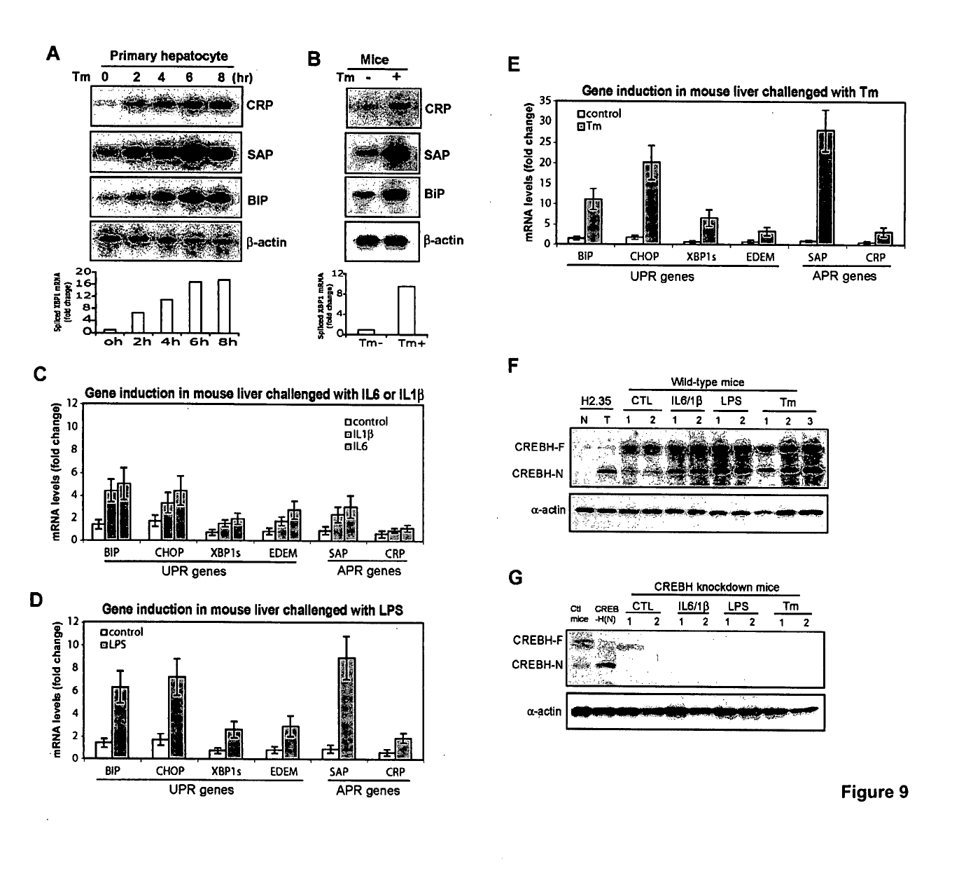

CREBH is a pro-inflammatory cytokine-inducible transcription factor that is specifically expressed in the liver (FIG. 1 and FIG. 2). This is consistent with the finding that expression of CREBH was induced from mid-late embryonic stage (FIG. 1C), a time when pro-inflammatory cytokines are highly secreted and the inflammatory response is established in the fetal liver (Zaret, 2002). The similarities between CREBH and ATF6 processing and activation led to speculation that CREBH may serve as a liver-specific UPR transducer. However, data indicated that CREBH had minor effects on trans-activation of the ERSE motif and of ER chaperone genes (FIG. 5D and FIG. 2D), suggesting that CREBH does not serve as a key trans-activator in transduction of the classic UPR signaling pathway. Interestingly, CREBH was able to activate the UPRE motif, and this effect was augmented by heterodimerization with ATF6 (FIG. 5E and FIG. 9C), suggesting that ER stress-induced CREBH cleavage may increase expression of some UPR target genes that contain UPRE motifs. However, it should be noted that the mammalian UPRE sequence was identified based on oligonucleotide binding to ATF6 (Wang et al., 2000). It is not known whether UPRE motifs present in mammalian genes actually contribute to UPR signaling (Yoshida et al., 2003).

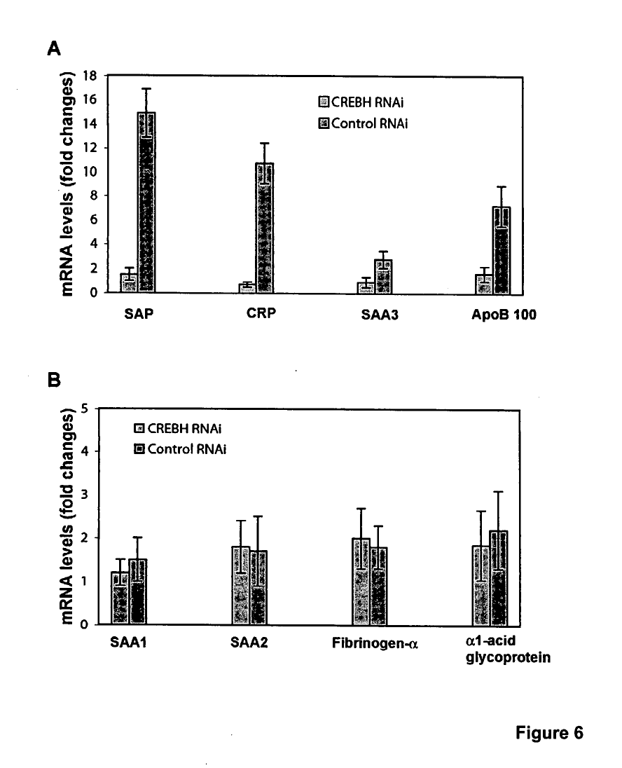

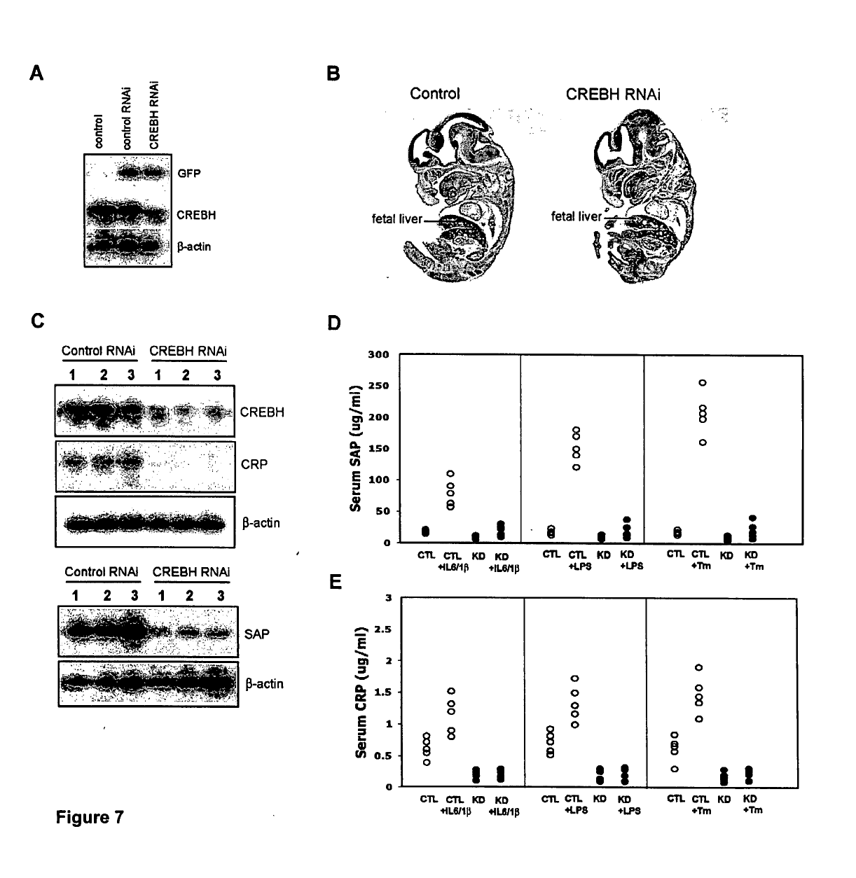

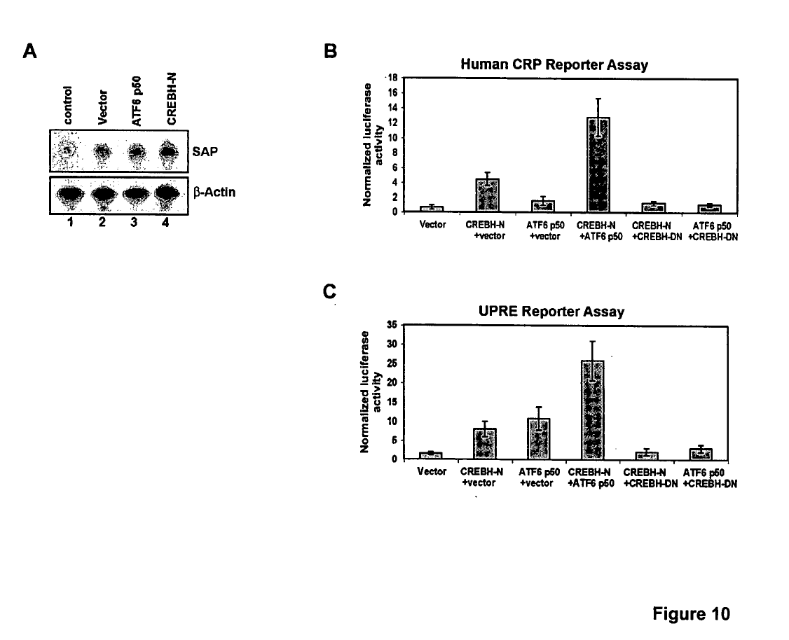

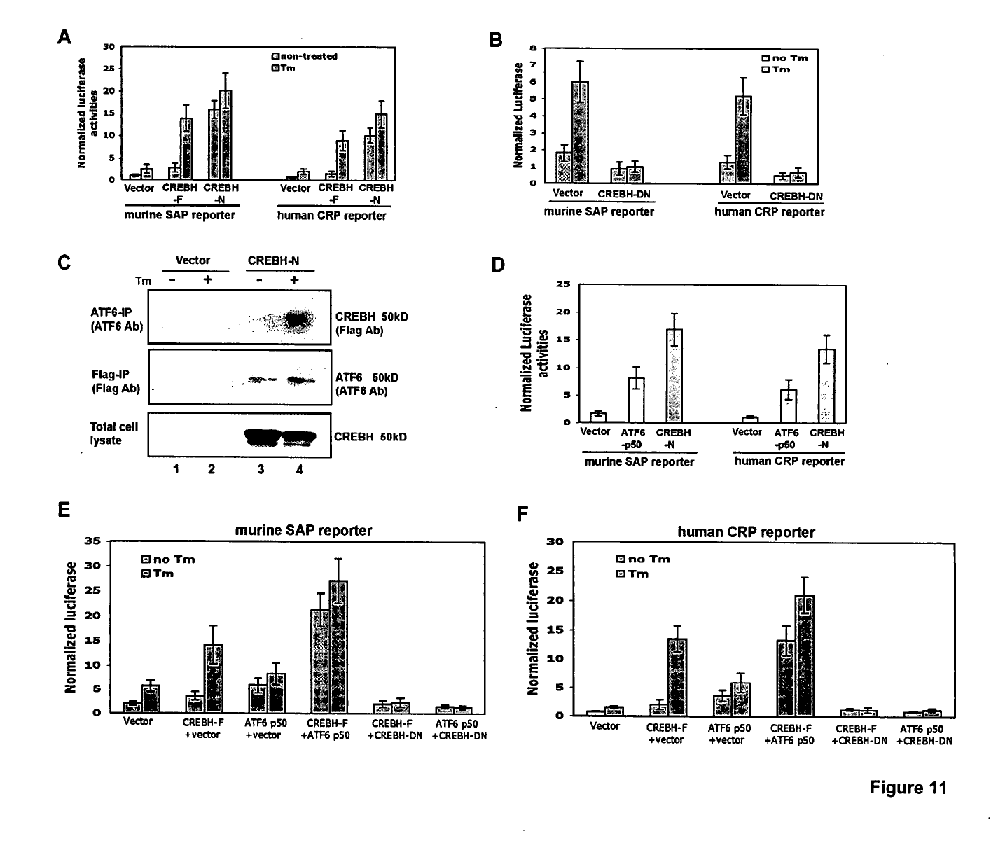

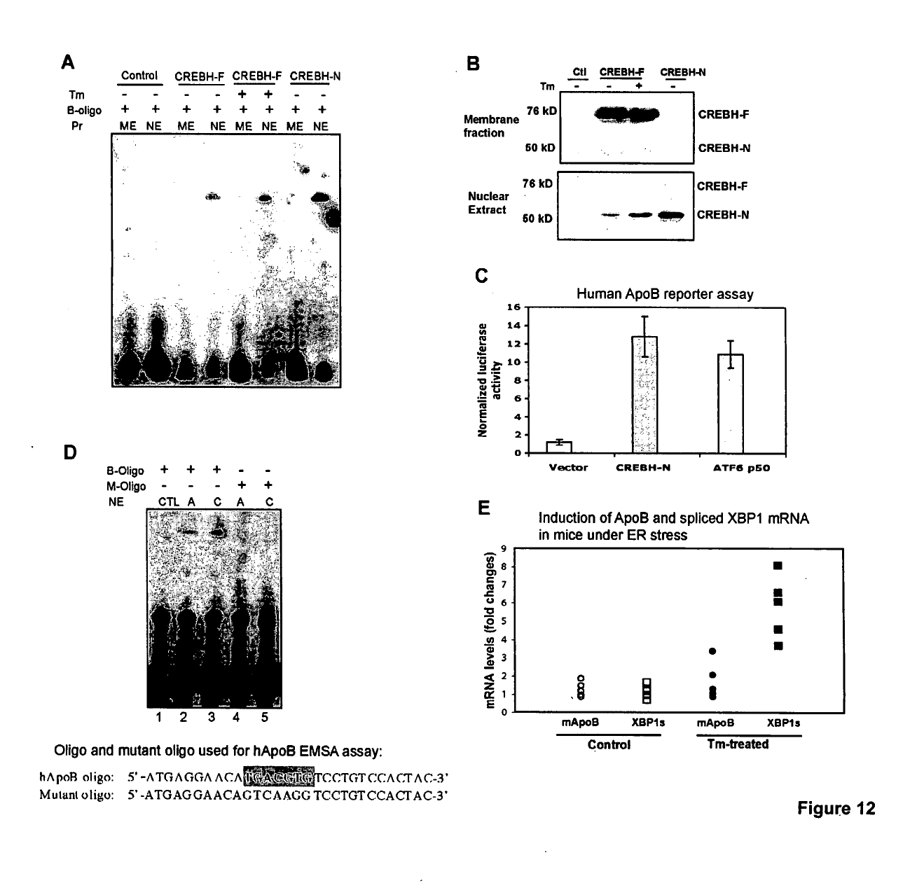

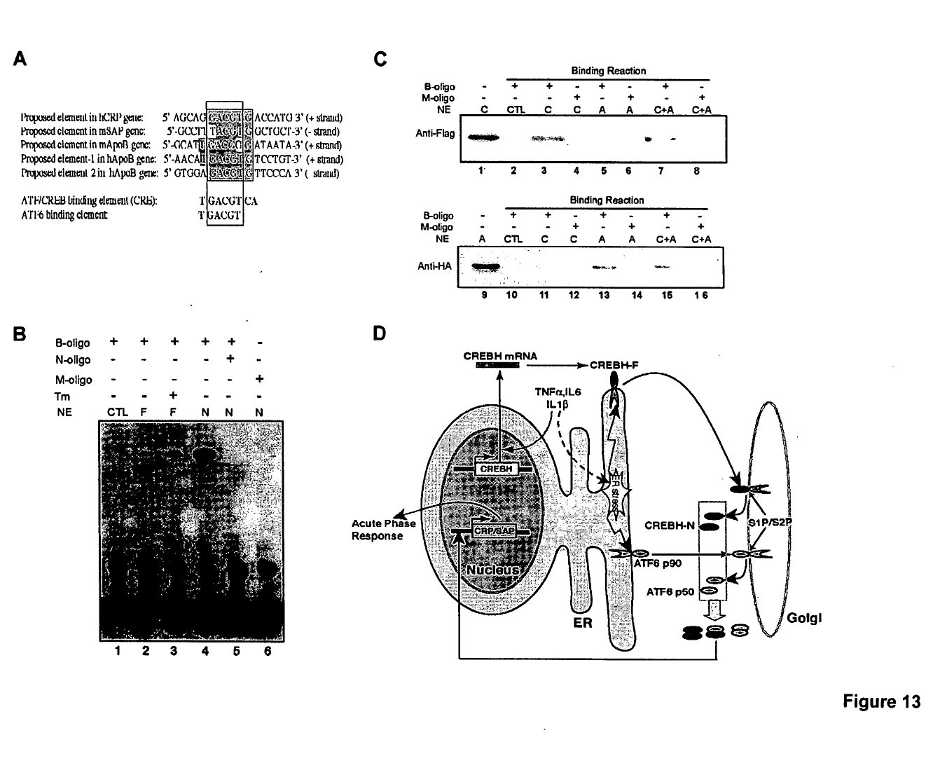

CREBH was originally identified as a transcription factor that binds to CRE and box B sequences (Omori et al., 2001). Indeed, a recent study reported that CREBH activated the promoter of hepatic gluconeogenic enzyme phosphoenolpyruvate carboxykinase (PEPCK) through binding to a CRE sequence in response to cAMP stimulation (Chin et al., 2005). Although deletion of the CREBH homologue in C. elegans caused embryonic lethality (K. Sakaki and R. J. Kaufman, unpublished observations), it has been shown that CREBH knockdown mice had no developmental defects and survived well under pathogen-free conditions (FIG. 7B). However, basal levels of mRNAs encoding acute phase proteins SAP, CRP, SAA3 and lipoprotein ApoB were significantly reduced in the fetal liver of CREBH knockdown mice (FIG. 7C and FIG. 6). Importantly, upon challenge with pro-inflammatory cytokines, bacterial LPS or Tm, CREBH knockdown mice showed severe defects in up-regulating their serum SAP and CRP levels (FIGS. 7D and E), suggesting that CREBH is required to activate expression of the CRP and SAP genes as part of the APR in response to pro-inflammatory cytokines as well as ER stress in vivo. This was supported by the findings that pro-inflammatory cytokines induce cleavage of CREBH in the liver (FIGS. 9F and G) and that transcription from human CRP and the murine SAP promoters was activated by cleavage and dimerization of CREBH (FIG. 11). Furthermore, the nuclear form of CREBH bound to a conserved DNA element in the promoter regions of the CREBH-regulated APR genes (FIG. 13 A-C and FIG. 12A-B), and activated expression of endogenous murine SAP mRNA upon expression of the nuclear form of CREBH in vivo (FIG. 10A). All these results suggest that pro-inflammatory stimuli and ER stress induce expression and cleavage of CREBH to activate transcription of specific APR genes.

ATF6 is another ER-localized bZIP transcription factor that is regulated by RIP in response to ER stress. ATF6 is ubiquitously expressed and was identified as a serum response element binding factor as well as a transcription factor that activates expression of ER chaperone genes, such as protein folding enzymes and factors involved in protein maturation, transport and ER-associated protein degradation during the UPR (Okada et al., 2002; Zhu et al., 1997). However, UPR transcriptional activation was intact in C. elegans deleted in atf-6 and in mammalian cells with reduced ATF6 (Lee et al., 2003; Shen et al, 2005), suggesting that ATF6 is dispensable for UPR signaling and may provide some other function. The finding that ATF6 activates promoters of the APR genes is significant because it is the first evidence for a physiological role of ATF6 during ER stress (FIG. 11D-F and FIG. 10A). Importantly, ATF6 forms heterodimers with CREBH in response to ER stress (FIG. 11C), and ATF6 and CREBH can both bind to the same conserved element present in APR genes to synergistically activate the human CRP and the murine SAP promoters (FIGS. 11E-F and 13C). These results show that activated ATF6 can serve as a potent enhancer to augment the acute inflammatory response. In addition, there is no evidence that CREBH interacts with other ER stress-inducible bZIP transcription factors, such as XBP1 or ATF4, to activate transcription (K. Zhang and R. J. Kaufman, unpublished observation), indicating that the ER stress-induced interaction between CREBH and ATF6 and the resultant synergistic trans-activation effects are specific and biologically significant. Finally, a recent study indicated that another family member of ER-localized transcription factors regulated by RIP, OASIS, also interacts with ATF6 to activate the UPR in astrocytes (Kondo et al., 2005). Thus, ATF6 may represent an ER stress-activated general dimerization partner for tissue specific transcription factors regulated by RIP, such as CREBH and OASIS. Therefore, ATF6 cleavage may activate different sets of target genes in different cell types.

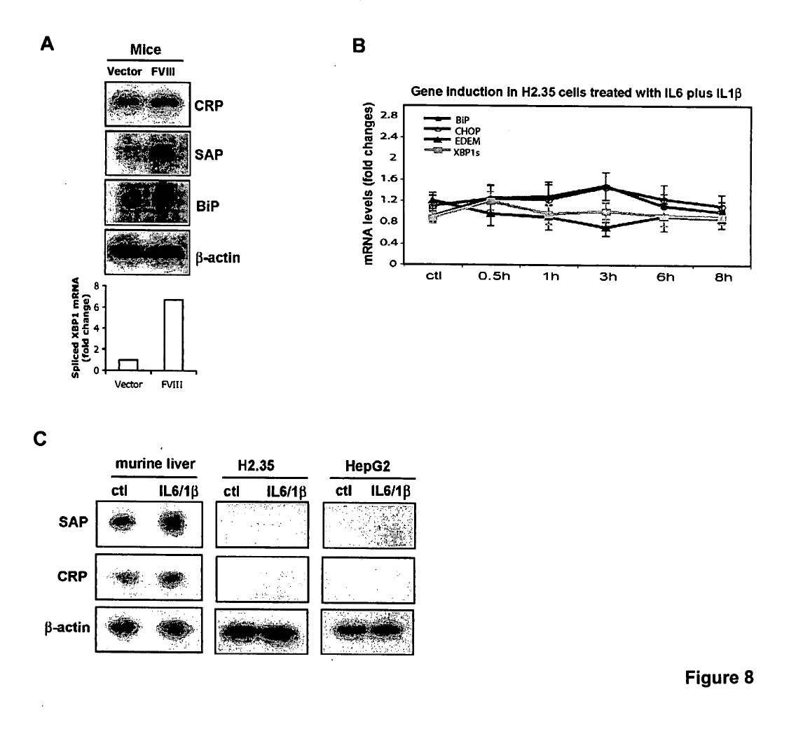

ER stress simultaneously activates the UPR and the APR in hepatocytes. For example, Tm treatment or elevated expression of clotting factor VIII activated expression of both UPR and APR genes in the livers of mice (FIG. 49A-B and FIG. 8A). Altered ER homeostasis, as well as the protein folding status in the ER, may therefore signal an inflammatory response. Many physiological and pathological processes, such as gene mutations that disturb protein folding, cholesterol or lipid overloading, hyperhomocysteinemia, nutrient deprivation, or infection with pathogenic organisms, can perturb ER function and cause ER stress (Kaufman, 2002). Injection of pro-inflammatory cytokines or LPS into mice has now been shown to induce significant ER stress and cleavage of CREBH in the liver (FIG. 9C-G). Thus, viral or bacterial infection or other pathological conditions may cause the release of pro-inflammatory cytokines as well as ER stress in vivo. For example, upon infection and expression of hepatitis C virus (HCV), glycoproteins E1 and E2 form disulfide-linked aggregates that cause ER stress and activate the UPR (Tardif et al., 2005). These CREBH findings suggest that, under conditions of infection and/or inflammation, pro-inflammatory cytokine-induced CREBH expression and ER stress-triggered CREBH cleavage synergistically contribute to activation of an acute inflammatory response.

It is appreciated that inflammation contributes significantly to the atherosclerotic process (Danesh et al., 2004; Hansson, 2005) and is associated with proatherogenic changes in lipoprotein metabolism that include increased VLDL and reduced HDL cholesterol levels (Khovidhunkit et al., 2000). Recent evidence suggests that plasma CRP level is as an important factor as cholesterol in assessing the risk of myocardial infarction, and may play a proatherogenic role during the APR (Danesh et al., 2004; Nissen et al., 2005; Paul et al., 2004; Ridker et al., 2005). Furthermore, elevated CRP in the plasma also predicts the occurrence of the metabolic syndrome and diabetes (Ridker et al., 2004). Therefore, elucidating the mechanism by which CREBH regulates CRP expression provides an understanding of the pathogenesis of coronary artery disease, and possibly diabetes. It is known that transcription factors C/EBPβ/β, STAT3, and Rel p50 all participate in CRP expression (Agrawal et al., 2001; Cha-Molstad et al., 2000; Majello et al., 1990; Zhang et al., 1996). Another novel set of transcription factors CREBH/ATF6 that also regulate CRP expression has now been identified. Interestingly, these factors are activated by ER stress, indicating a link between ER stress and associated pathological increases in CRP. The studies presented herein using CREBH knockdown mice reveal that CREBH-mediated signaling is required to potently induce the APR.

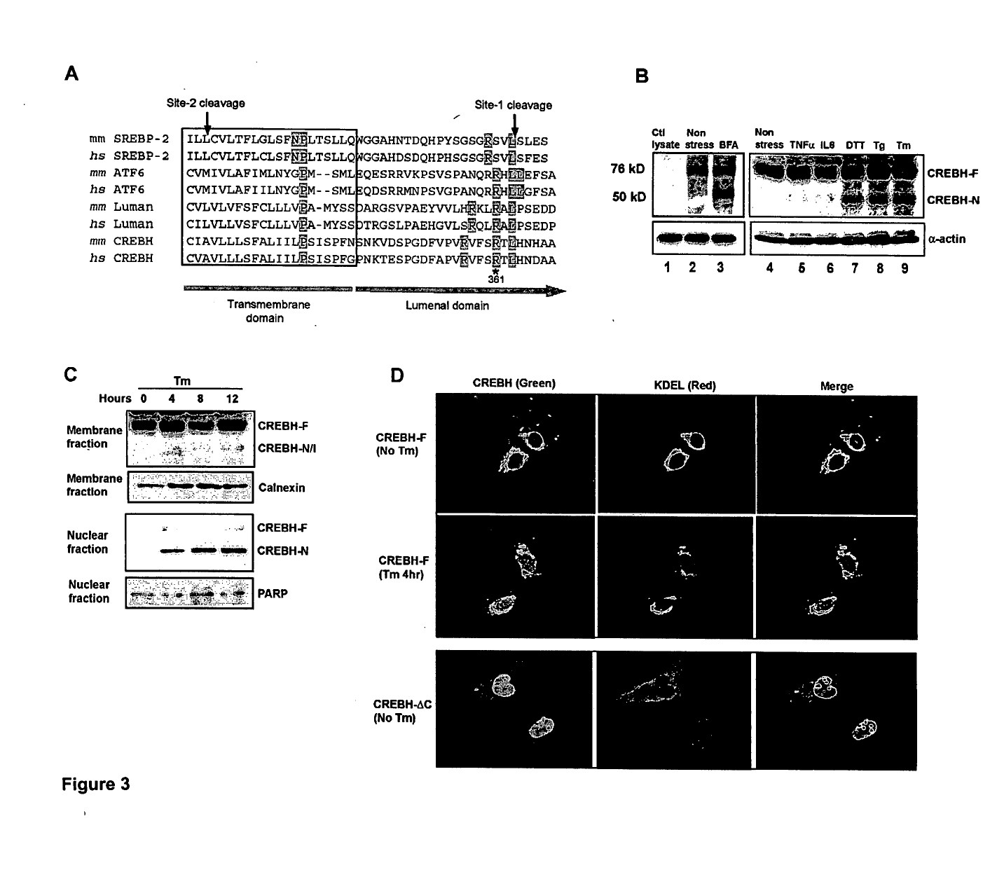

ER stress may contribute to atherosclerosis through both transcriptional and post-transcriptional mechanisms. CRP forms pentamers in the ER where they are retained by two ER resident carboxylesterases (Macintyre et al., 1994; Yue et al., 1996). Upon activation of the APR, there is a dramatic change in the ER trafficking of CRP (Macintyre, 1992). Therefore, ER stress may contribute to atherosclerosis at a post-translational level by influencing protein trafficking within the ER to impact the folding and secretion efficiency of APR gene products. In addition to CRP, ApoB, the essential component of VLDL and LDL, is also known to be regulated by ER homeostasis at a post-translational level (Fisher and Ginsberg, 2002). Interestingly, induction of the ApoB mRNA was decreased in the CREBH knockdown fetal liver (FIGS. 3 and 6). The promoter regions of both the human and murine ApoB genes contain the proposed CREBH/ATF6-binding element identified in the human CRP gene (FIG. 13A). Indeed, both CREBH and ATF6 can bind to the proposed element in the human ApoB gene and activate transcription from the human ApoB promoter (FIGS. 12C and D).

In summary, the present invention provides a novel ER stress-response pathway mediated by CREBH and regulated by RIP (FIG. 13D). Transcription of CREBH mRNA in hepatocytes is induced by pro-inflammatory cytokines TNFα, IL6 and IL1β. CREBH mRNA encodes a bZIP transcription factor that localizes to the ER. Upon ER stress caused by pro-inflammatory cytokines, both ATF6 and CREBH transit from the ER and transit to Golgi complex where they are cleaved by proteases S1P and S2P to release their activated forms. Activated ATF6 and CREBH traffic into the nucleus, dimerize and synergistically activate expression of the major APR genes (FIG. 13D). The finding that ER stress activates an inflammatory response provides impetus for studies to elucidate what contribution ER stress makes to the variation in CRP level in the general population.

Practice of the invention will be still more fully understood from the following exemplification, which is presented solely to illustrate principles and operation of the invention, and should not be construed as limiting scope of the invention in any way.

### EXEMPLIFICATION

Experimental Procedures

Plasmid DNAs

Plasmids, pME18S, pME-CREBH Full and pME-CRE1H d™ were kindly provided by Dr. Sumio Sugano (Institute of Medical Science, University of Tokyo, Japan) (Omori et al., 2001). Plasmid pFlag-CREBH Full that expresses a full-length CREBH (amino acids 1-455) was constructed by insertion of a PCR product from pME-CREBH Full into expression vector pFlag-CMV-4 between EcoR I and BamH I. Vector pFlag-CMV-4 is designed for stable, cytoplasmic expression of N-terminal flag fusion proteins in mammalian cells (purchased from Sigma-Aldrich). Plasmid pFlag-CREBH-ΔC that expresses the nuclear form of CREBH (amino acids 1-320) was constructed by insertion of a PCR product from pME-CREBH d™ into pFlag-CMV-4 between EcoR I and BamH I. Plasmid pFlag-CREBH-DN that expresses only the CREBH bZIP domain (amino acids 209-320) was constructed by insertion of a PCR product from pME-CREBH Full into pFlag-CMV-4 between EcoR I and BamH I. The reporter plasmid containing the luciferase gene under control of the human CRP gene, pGL3-CRP, was constructed by insertion of a 637 bp fragment containing 5′-flanking and promoter region of the human CRP gene into luciferase reporter vector pGL3-basic (purchased from Promega, Madison, Wis.) between Sac I and Xho I. The 637 bp 5′-flanking fragment of the human CRP gene was amplified from human genomic DNA by using a forward primer: 5′-CGAGCTCACATGTATACATATGTAAC-3′; and a reverse primer 5′-CCGCTCGA GTGATACAAGGGCCTGAAT-3′. The reporter plasmid containing the luciferase gene under control of the mouse SAP gene, pGL3-SAP, was constructed by insertion of an 863 bp fragment containing 5′-flanking and promoter region of the mouse SAP gene into pGL3-basic between Xho I and Hind III. The 863 bp mouse gene fragment was amplified from mouse genomic DNA by using a forward primer: 5′-CCGCTCGAGCCTGGGAAT GAGTGTACA-3′; and a reverse primer: 5′-CCCAAGCTTGGTCCAGGGTATGACA-3′. Expression vectors for S1P-KDEL and S1P-KDAS an pCMV-S2P were kindly provided by Dr. Peter J. Espenshade (Department of Cell Biology, Johns Hopkins University School of Medicine, Maryland, USA). The luciferase reporter construct under control of five UPRE sequence, p5×UPREGL3, was kindly provided by Dr. Ron Prywes (Department of Biological Science, Columbia University, New York, USA). The luciferase reporter construct under control of the BiP promoter/ERSE element was previously described (Tirasophon et al., 1998). The CREBH mutant construct, R361A was constructed by using a QuikChange Site-Directed Mutagenesis Kit according to the manufacturer's instructions (Strategene, La Jolla, Calif.). Primers used for generating R361A were: 5′-CGAGTGTTCTCCGCAACTTTGCACAACGATGCTGC-3′; and 5′-ATCGTTGTGCAAAGTTGCGGAGAACACTCGTACAGGC-3′. The mutation was confirmed by DNA sequencing.

Cell Culture and Transfection

The murine primary hepatocyte cell line H2.35 was purchased from ATCC (Manassas, Va.). H2.35 cells were cultured in DMEM (containing 1 g/L glucose) supplemented with 2 mM Glutamine, 250 nM Dexamethasone and 4% Fetal Bovine Serum (FBS) on collagen-coated plates (Zaret et al. 1998). Cell lines were maintained in a 5% CO₂ atmosphere at 33° C. Transfection was carried out by using Lipofectamine 2000 (Invitrogen, Carlsbad, Calif.) or Fugene 6 (Roche Applied Science) according to the manufacturer's instructions. The H2.35 cell line is temperature sensitive for expression of liver-specific genes. At 24 hours after transfection, H2.35 was incubated at 39° C. for expression of liver-specific genes. COS7 cells were grown in Dulbecco's modified Eagle's medium supplemented with 10% fetal calf serum in a 5% CO₂ atmosphere at 37° C. Primary hepatocytes were isolated from fetal livers of C57BL/6J mice at embryonic stage E18 as previously described (Mackey and Darlington, 2004). Wild-type (K1). S1P-deficient (SRD-12B) and S2P-deficient (M19) CHO cells were kindly provided by Drs. Michael Brown and Joseph Goldstein (University of Texas Southwestern Medical Center, Dallas, Tex.), and were cultured as previously described (Hasan et al., 1994; Rawson et al., 1997).

Immunofluorescent Microscopy

Immunofluorescence staining was performed as previously described (Paterson et al., 1995). Briefly, COS7 cells were plated onto chamber slide (Lab-Tek Chamber Slide System, Nalge Nunc International Corp., Naperville, USA) and transfected with CREBH expression vector and vector expressing KDEL-RFP (kindly provided by Dr. Jennifer Lippincott-Schwartz, National Institute of Child Health and Human Development, National Institutes of Health, Bethesda, USA). At 36 hr post-transfection, the cells were treated with Tm for various time periods, and were then stained with FITC-conjugated mouse anti-flag monoclonal antibody (Sigma-Aldrich). The fluorescence images were examined by a confocal laser scanning fluorescence microscopy using an LSM510 (Carl Zeiss, Thornwood, N.Y.).

Generation of CREBH Knockdown Mice

Generation of RNA interference transgenic mice was performed as described previously (Rubinson et al., 2003). Briefly, vectors that express hairpin siRNAs under the control of the mouse U6 promoter were constructed by inserting pairs of annealed DNA oligonucleotides into the LentiLox3.7 vector (kindly provided by Dr. Luk Van Parijs at Massachusetts Institute of Technology) between the HpaI and XhoI restriction sites. The sequence used for CREBH RNAi is: TCGAGAAAAAAGACATAGCGGCTGGAAA GATCTCTTGAATCTTTCCAGCCGCTATGTCA. The clones and packaging vectors including VSVG, RSV-REV, pMDL g/p RRE were co-transfected into 293T cells. The supernatants were collected at 36 hrs post-transfection and the viruses were concentrated by ultracentrifugation at 25,000 rpm for 90 mins and resuspended in 15 μl cold phosphate-buffered saline. Titers were determined by infecting 293T cells with serial dilutions. The GFP expression in cells at 48 hrs post-infection was analyzed by flow cytometry. A small volume of high-titer RNAi lentivirus (approximately 5×10⁶ IU μl⁻¹) was transferred into the perivitelline space of single-cell C57BL/6J mouse embryos through microinjection. The injected single-cell embryos were implanted into pseudopregnant recipient mice. The resulting embryos were screened for lentiviral integration by examining expression of GFP. The CREBH knockdown mice were confirmed by expression of GFP and degradation of CREBH mRNA in the liver.

Northern Blot Analysis

Northern blot analysis was performed according to standard procedures (Sambrook et al., 1989). ³²P-labeled probes were prepared using a random prime labeling system (Amersham Pharmacia, Piscataway, N.J., USA). A 210 bp mouse CREBH cDNA fragment, a 250 bp mouse CRP cDNA fragment and a 260 bp mouse SAP cDNA fragment were amplified from murine total RNA by reverse transcription-PCR system (Roche Applied Science), respectively, and were used as probes for Northern blot analyses. Total RNA (15 μg) per sample purified from cultured cells or murine tissues was used for Northern blot analysis. Quantitative real-time RT-PCR was performed as previously described (Back et al., 2005). Briefly, total cellular RNA prepared was reverse-transcribed to cDNA using a random primer (Applied Biosystems). The reaction mixture, containing SYBR Green PCR Master Mix (Applied Biosystems), was run in a 7900HT Fast Real-Time PCR System (Applied Biosystems). Real-time PCR primer sequences for quantification of murine XBP1 mRNA splicing are: the forward primer 5′-GAGTCCGCAGCAGGTG-3′, and the reverse primer 5′-GTGTCAGAGTCCATGGGA-3′. Other primer sequences were designed by Primer Express (Applied Biosystems).

Luciferase Reporter Analysis

At 36 h post transfection, transfected cells were lysed and assayed for luciferase and β-galactosidase activity by using a Tropix Luciferase/β-Galactosidase Dual Light. Reporter Assay kit according to the manufacturer's instructions (TROPIX, Bedford, Mass., USA). Photons were detected in an Optima II Luminator (MGM Instruments). The amount of luciferase activity was normalized to the amount of β-galactosidase activity to correct for transfection efficiency in each experiment.

Western Blot Analysis and Immunoprecipitation

For analysis of expression and cleavage of CREBH protein, total cell lysates were prepared from H2.35 cells or COS7 cells using Nonidet P-40 lysis buffer (1% NP-40, 50 mM Tris-HCl at pH 7.5, 150 mM NaCl, 0.05% SDS) supplemented with protease inhibitors (Complete Mini from Roche Applied Science), 0.1 mM sodium vanadate, and 1 mM sodium fluoride. Membrane and nuclear fractions of cell lysates were isolated as previously described (Dignam et al., 1983). The total cell lysate, membrane and nuclear fractions were subjected to SDS-PAGE and then analyzed by Western blot using anti-flag monoclonal antibody or other antibodies. Immunoprecipitation and Western blot analyses of ATF6 and CREBH interaction in 293T cells expressing flag-tagged CREBH protein were performed by using anti-human ATF6 and anti-flag antibodies. Total cell lysates from 293T cells transfected with control vector or pFlag-CREBH-ΔC were immunoprecipitated with anti-human ATF6 polyclonal antibody and anti-flag antibody, respectively. The immunoprecipitated cell lysates were then subjected to Western blotting by using anti-flag antibody to detect CREBH protein and using anti-human ATF6 antibody to detect ATF6 protein, respectively. The same total cell lysates were subjected to Western blotting by using anti-flag antibody to detect expression of CREBH protein in the transfected cells. For detecting endogenous CREBH protein in the liver extracts, an anti-mouse CREBH polyclonal antibody was raised in rabbits against a purified mouse CREBH peptide composed of amino acids 92-109 [EDLPSDPQDTPPRSGTEP]. The rabbit anti-human ATF6 polyclonal antibody was generated in the inventor's laboratory. The anti-mouse calnexin monoclonal antibody and the anti-mouse monoclonal PRAP antibody were purchased from Stressgen Biotechnologies (Victoria, BC, Canada) and BD Bioscience (Mountain View, Calif., USA), respectively.

Administration of LPS and Measurement of Serum CRP and SAP in Mice

Pro-inflammatory cytokines recombinant murine IL6 (BD Pharmingen), recombinant murine IL1β (R&D System, Minneapolis, Minn.) and bacterial LPS (Sigma, St. Louis, Mo.), and was re-suspended in sterile pyrogen-free 0.9% NaCl (Abbott Laboratories, North Chicago, Ill.). CREBH knockdown and control RNAi mice at age of 3-months were given a single intraperitoneal injection of IL6 (25 ng/gram body weight) plus IL1β (25 ng/gram body weight) or LPS (3 μg/gram body weight). CREBH knockdown and control RNAi mice at same age where injected intraperitoneally with Tm (2 μg/gram body weight) in 150 mM dextrose solution. Sera from blood samples were collected from the mice before and 24 h after injection of LPS. Serum levels of mouse CRP were determined using a mouse CRP ELISA kit (ALPCO Diagnostics, Windham, N.H., USA). Serum levels of mouse SAP were determined by ELISA analysis using sheep anti-Mouse SAP as the capture antibody (Alpha Diagnostic Intl., Inc., San Antonio, Tex.), and mouse SAP reference serum from the same company.

EMSA and DNA-Protein Binding Assay

EMSA analysis was performed by using a Lightshift Chemiluminescent EMSA kit (PIERCE, Rockford, Ill.) according to the manufacturer's instructions. Reactions were performed using 20 μg NE from COS1 cells transfected with empty vector or vector expressing CREBH and/or ATF6 and 100 fmol biotin-labeled DNA probe. The human CRP probe sequence used for EMSA was 5′-ACTGGCAGCAGGACGTGACC ATGGAG-3′; the mutant probe was 5′-ACTGGCAGCAGACAACTACCATGGAG-3′. In addition, a 200-fold excess of unlabeled DNA probe was used for competition assay. DNA-Protein Binding Assays were carried out by using streptavidin-coated beads to bind biotinated DNA probe, which was used to interact with nuclear extract proteins as previously described (Zhu et al., 2002). The binding reaction was performed by mixing 600 μg of NE proteins from transfected COS1 cells, 6 μg of biotin-labeled DNA probe, and 60 μl of streptavidin-coated beads with slurry (PIERCE, Rockford, Ill.). The mixture was incubated at room temperature for 1 h with shaking. The beads were pelleted and washed with PBS for at least 3 times. The binding proteins were separated by SDS-PAGE followed by Western blot analysis probed with specific antibodies.

Results

CREBH is Expressed in Fetal Liver from Mid-Late Embryonic Stage and is Inducible by Pro-Inflammatory Cytokines.

Previously, microarray analysis in C. elegans identified a novel IRE1-dependent and XBP1-dependent ER stress-responsive gene, F57B10.1, which encodes a bZIP transcription factor homologous to mammalian CREBH (Shen et al., 2005). Mammalian CREBH is a bZIP transcription factor that belongs to the CREB/ATF family (Omori et al., 2001). Structural comparison of bZIP transcription factors of the ATF/CREB family indicated that CREBH has an overall structure similar to that of ATF6 and Luman (Omori et al., 2001; Raggo et al., 2002) (FIG. 1A). However, in contrast to ATF6, CREBH expression is strictly restricted to liver tissue (Omori et al., 2001) (FIG. 1B). Analysis of CREBH expression during development by Northern blot analysis revealed that transcription of CREBH mRNA was first detected at gestation stage E12.5 and reached a peak level around E16.5 (FIG. 1C). In addition, in murine H2.35 hepatoma cells, CREBH mRNA was induced in a time-dependent manner upon treatment with either interleukin-6 (IL6) (FIG. 1D), IL1β, or tumor necrosis factor α (TNFα) (FIG. 2A). In addition, ER stress inducers dithiothreitol (DTT), thapsigargin (Tg) and Brefeldin A (BFA) that are known to activate the UPR, as well as activate NF-κB to stimulate production of pro-inflammatory cytokines (Kaufman, 1999; Pahl, 1999), also significantly induced transcription of CREBH mRNA (FIG. 2A-C). In contrast, tunicamycin (Tm), a drug that blocks asparagine (N)-linked glycosylation and thus induces the UPR, had a minor effect on induction of CREBH mRNA in hepatocyte cell lines, including H2.35 and HepG2 cells (FIG. 2A-C). These results suggest that pro-inflammatory cytokines are strong inducers for CREBH mRNA expression in hepatocytes.

ER Stress Induces Cleavage of CREBH to Release its N-Terminal Cytosolic Fragment that Translocates to the Nucleus.

Comparison of CREBH with the known RIP-regulated ER-localized proteins including SREBP, ATF6 and Luman indicated a high degree of sequence conservation within the putative transmembrane domains (Ye et al., 2000b) (FIG. 3A). The homologies between CREBH, SREBP, ATF6 and Luman led to the proposal that CREBH may be subject to RIP-mediated cleavage for its activation. To identify stimuli that might induce cleavage of CREBH, an amino (N)-terminal flag-tagged human CREBH protein was stably expressed in the murine H2.35 hepatocyte cell line and examined cleavage of CREBH by Western blot analysis using an anti-flag antibody. This approach is similar to that used to study cleavage of ATF6 (Nadanaka et al., 2004; Ye et al., 2000b). Under normal conditions, CREBH localizes to the ER and S1P and S2P are located in the Golgi compartment. Therefore, it was tested whether BFA, a reagent that induces the collapse of the Golgi into the ER, potentiates cleavage of CREBH. Indeed, it was found that BFA treatment induced cleavage of CREBH to release a 50 kD N-terminal fragment (FIG. 3B, lane 3). Next, the H2.35 cells stably expressing CREBH were treated with various pro-inflammatory cytokines and drugs that induce ER stress. Although IL6 or TNFα strongly induced expression of the CREBH mRNA (FIG. 1 and FIG. 2), neither of them significantly induced CREBH cleavage (FIG. 3B, lanes 5 and 6). In contrast, ER stress inducers including DTT, Tm and Tg all significantly induced cleavage of CREBH to release a 50 kD N-terminal fragment (FIG. 3B). Therefore, where transcription of CREBH is activated by the pro-inflammatory cytokines, processing of CREBH appears activated by stress in the ER.

Cell fractionation experiments demonstrated that in the absence of ER stress, the 76 kD full-length CREBH protein (designated as CREBH-F) was detected exclusively in the membrane fraction, similar to calnexin, a transmembrane molecular chaperone localized to the ER (FIG. 3C). When the cells were treated with Tm, the 50 kD N-terminal cleaved CREBH fragment was exclusively detected in the nuclear fraction, and the amount of this fragment gradually increased with increasing times of Tm treatment (FIG. 3C). The distribution of cleaved CREBH was similar to that of the nuclear protein, poly-ADP ribose polymerase (PARP). These results suggest that cleavage of CREBH under ER stress produces a nuclear form of CREBH (CREBH-N). Note that CREBH protein expressed in transfected cells migrated with an apparent molecular mass of approximately 76 kD, larger than 55 kD predicted from its amino acid sequence. This may be partially due to posttranslational phosphorylation that is observed in other bZIP transcription factors of ATF/CREB family (Shaywitz and Greenberg, 1999).

To further confirm the relocalization of CREBH from the ER to the nucleus during ER stress, confocal immunofluorescence microscopy was performed. In the absence of ER stress, CREBH expressed in COS7 cells displayed a fine reticular localization surrounding the nucleus (FIG. 3D). The CREBH green fluorescence overlapped with fluorescence obtained from ER-localized red fluorescence protein (RFP-KDEL), indicating that CREBH was localized to the ER under non-stressed conditions. When cells were treated with Tm for 4 hours, a significant portion of the immunoreactive CREBH protein accumulated in the nucleus (FIG. 3D). Note that a large portion of CREBH protein was retained in the ER after Tm treatment. These results were consistent with the cell fractionation experiments (FIGS. 3B and C) that show redistribution of a portion of CREBH to the nucleus, and suggest that CREBH is cleaved upon ER stress to release its N-terminal portion that translocates to the nucleus. In addition, a C-terminal CREBH delection (CREBH-ΔC) was constructed that lacks the putative transmembrane domain and lumenal domain but contains the trans-activation domain and the b-Zip domain. Confocal analysis showed that CREBH-ΔC exclusively localized to the nucleus (FIG. 3D), suggesting that CREBH-ΔC is a nuclear form of CREBH.

CREBH is Cleaved by S1P and S2P Proteases in Response to ER Stress.

Alignment of transmembrane domains and lumenal domains of CREBH, SREBP, ATF6 and Luman proteins revealed an R×××R sequence and an R×L sequence located in the lumenal domain of CREBH at sites of 14 and 18 residues from the transmembrane domain, respectively (FIG. 3A). Furthermore, CREBH has a proline in its hydrophobic transmembrane domain at a location similar to the conserved proline for S2P cleavage identified in SREBP and ATF6 (Ye et al., 2000a; Ye et al., 2000b). These observations led to the proposal that CREBH may be processed by the same proteases S1P and S2P that cleave ATF6 and SREBP. To test the potential for S1P to cleave CREBH, flag-tagged CREBH was co-expressed with an ER-localized version of S1P, S1P-KDEL, in COS7 cells. This method was first employed to demonstrate S1P cleavage of SREBP within the ER in the absence of trafficking to the Golgi (DeBose-Boyd et al., 1999). As an additional control, full-length CREBH was expressed with S1P-KDAS, which is not retrieved to the ER and does not cleave SREBP or ATF6 (DeBose-Boyd et al., 1999). Whereas only a minor portion of full-length CREBH was cleaved in the presence of S1P-KDAS (FIG. 5A, lanes 4-5), expression of S1P-KDEL induced substantial cleavage of full-length CREBH, generating an N-terminal product that co-migrated with the 50 kD CREBH product induced by BFA treatment (FIG. 5A, lanes 6-7). This N-terminal fragment also co-migrated with CREBH-ΔC, the CREBH cyotosolic fragment that lacks the putative transmembrane and luminal domains, and localizes to the nucleus (FIG. 5A, lane 1; FIG. 3D). Here, CREBH-ΔC is defined as a nuclear form of CREBH (CREBH-N).

To directly investigate the possibility that CREBH is processed by S1P and S2P in response to ER stress, cleavage of CREBH was examined in wild-type (K1), S1P-deficient (SRD-12B) and S2P-deficient (M19) Chinese hamster ovary (CHO) cells (Hasan et al., 1994); Rawson et al., 1998; Rawson et al., 1997). Different from stably-transfected H2.35 cells (FIG. 3B), wild-type CHO cells transiently transfected with the CREBH expression vector exhibited a small amount of cleaved CREBH in nuclear fraction in the absence of Tm treatment (FIG. 5B, lane 2). This cleavage is believed to be partially due to ER stress resulting from overproduction of flag-tagged CREBH, since a similar phenomenon that was observed for ATF6 (Ye et al., 2000b). Despite this background cleavage of CREBH, the nuclear form of CREBH was increased approximately 6-fold in the transfected wild-type CHO cells after Tm treatment (FIG. 5B, line 3). By comparison, S2P-deficient CHO cells (M19) did not produce a nuclear form of CREBH in the absence or presence of Tm. However, a cleaved intermediate (CREBH-I) was detected in the membrane fraction of M19 cells, which might result from cleavage at the S1P site (FIG. 5B, lanes 5 and 6). To confirm the role of S2P in CREBH cleavage, M19 cells were cotransfected with a construct expressing wild-type S2P to restore CREBH processing (Rawson et al., 1997; Ye et al., 2000b). Expression of S2P in M19 cells restored production of the nuclear form of CREBH in the presence of ER stress (FIG. 5B, line 7). Furthermore, in S1P-deficient CHO cells (SRD-12B), production of the nuclear form of CREBH was decreased in the absence or presence of ER stress, compared to that in wild-type CHO cells (FIG. 5B, lanes 9 and 10). Expression of wild-type S1P in SRD-12B cells significantly increased production of the nuclear form of CREBH in response to ER stress (FIG. 5B, lane 11) (Sakai et al., 1998b). Note that a small amount of the nuclear form of CREBH was detected in the S1P-deficient cells that might result from inefficient S2P cleavage in the absence S1P. In addition, small amounts of alternatively cleaved forms of CREBH were observed in the membrane fraction of SRD-12B cells (FIG. 5B, lanes 9 and 10). This suggests that CREBH may be alternatively processed if it fails to undergo S1P cleavage.

Since the R×××R×L motif in CREBH is similar to the identified S1P recognition motifs (R××R) or R××L) (Cheng et al, 1999; Toure et al., 2000), the next experiment tested whether the central Arg, R361, is required for S1P-mediated cleavage by replacing R361 with Ala (R361A). A vector was constructed to express flag-tagged R361A mutant CREBH in COS7 cells. Compared to the cells that express wild-type CREBH, production of the nuclear form of CREBH was reduced in the cells expressing the R361A mutant CREBH in the presence of ER stress (FIG. 5C, lane 4). This result suggests that R361 is a residue required for efficient cleavage of CREBH by S1P, and thus further confirms S1P-mediated cleavage of CREBH occurs upon ER stress.

CREBH Acts on the UPRE, but not the ERSE

Since ER stress induces cleavage of CREBH, it was tested whether CREBH serves as a UPR transcriptional activator, like ATF6 or XBP1. In mammalian cells, UPR transcriptional induction is mediated through a cis-acting ER stress-response element (ERSE) having the consensus sequence CCAAT-N₉-CCACG in the promoter regions of responsive genes (Yoshida et al., 1998). GRP78/BiP is a major ER chaperone gene that is up-regulated by the UPR trans-activators XBP1 and ATF6. The BiP promoter contains three tandem copies of the ERSE motif. To test whether CREBH activates the ERSE motif, the CREBH expression vector was co-transfected with a luciferase reporter under control of the BiP promoter. As positive controls, the luciferase reporter construct was co-transfected with a vector expressing full-length ATF6 (ATF6 p90) or cleaved ATF6 (ATF6 p50). Consistent with previous reports, ATF6 p90 significantly activated expression of luciferase from the BiP/ERSE reporter after ER stress, and ATF6 p50 activated the reporter to a greater extent before and after ER stress (FIG. 5D) (Haze et al., 1999). In contrast, full-length CREBH (CREBH-F) or the nuclear form (CREBH-N) did not significantly increase expression of luciferase from the ERSE reporter (FIG. 5D). Although Tm treatment slightly increased expression from the ERSE luciferase reporter in the cells expressing the full-length or nuclear form of CREBH, this effect was probably mediated through endogenous ATF6 or XBP1 protein. This result is consistent with Western blot analysis showing that expression of endogenous ER chaperones BiP and GRP94 was not affected by over-expression of CREBH-N, whereas over-expression of the nuclear form of ATF6, ATF6 p50, significantly increased expression of BiP and GRP94 (FIG. 2D). Moreover, expression of CREBH had very little effect on expression of other UPR-activated target genes including calreticulin, Erp72 and protein disulfide isomerase (data not shown). Together these results suggest that CREBH does not serve as a key UPR trans-activator for expression of classic ER chaperone genes.

The effect of CREBH was tested on another ER stress-responsive cis-acting element, the UPR element (UPRE), which has the sequence TGACGTGG/A (Wang et al., 2000; Yoshida et al., 1998). Co-expression of CREBH activated luciferase expression under control of a multimerized UPRE motif by approximately 2-fold relative to that of the vector control (FIG. 5E). After Tm treatment, CREBH-F activated the UPRE reporter by more than 10-fold. CREBH-N activated expression of the UPRE reporter approximately 18-fold (FIG. 5E), further confirming the potential for CREBH to activate the UPRE. Note that expression of luciferase from the UPRE reporter in the cells expressing full-length CREBH was increased in the absence of Tm. This effect may be due to cleavage of CREBH under ER stress caused by over-expression of full-length CREBH, a similar phenomenon observed for ATF6 (Nadanaka et al., 2004; Ye et al., 2000b). Moreover, Tm treatment further increased expression from the UPRE reporter in cells expressing the nuclear form of CREBH. This additional increase may result from activation of endogenous ATF6 by Tm treatment. Taken together, these results suggest that CREBH may modulate transcriptional induction of some ER stress-responsive genes that contain UPRE sequences in their promoter regions, although CREBH does not act as a typical UPR trans-activator like ATF6 or XBP1.

The identification of the UPRE as a CREBH target enabled further delineation of the ER stress-induced mechanism of CREBH activation by using the UPRE reporter assay. To demonstrate the requirement of S1P- and S2P-mediated cleavage for CREBH activation and function, the UPRE luciferase reporter construct and the construct expressing full-length or nuclear form of CREBH were co-transfected into wild-type, S1P-deficient and S2P-deficient CHO cells, respectively. After Tm treatment, CREBH-F significantly activated expression of luciferase from the UPRE reporter in wild-type CHO cells (FIG. 5F). CREBH-N had a more significant effect on expression of the UPRE reporter compared to CREBH-F. In contrast, CREBH-F had a minor effect on activation of the UPRE reporter in S1P- or S2P-deficient CHO cells, even after Tm treatment (FIG. 5F). However, expression of the nuclear/cleaved form of CREBH efficiently activated the UPRE reporter in S1P- and S2P-deficient CHO cells, to a similar level of that in wild-type CHO cells. In addition, Tm had no effect on trans-activation of the UPRE reporter mediated by CREBH-ΔC in S2P-deficient CHO cells (FIG. 5F). These results indicate that both S1P- and S2P-mediated cleavages are required for full-length CREBH to elicit its transcriptional activity upon ER stress.

CREBH is Required to Induce Expression of the Acute Phase Response Genes Serum Amyloid P-Component (SAP) and C-Reactive Protein (CRP)

To explore the physiological function of CREBH, the CREBH gene in the mouse was silenced by using a lentivirus-based system that expresses CREBH-specific hairpin small interfering RNAs (siRNAs) (Rubinson et al., 2003). CREBH-specific RNAi lentivirus was injected into single-cell mouse embryos to generate CREBH-knockdown mice. Empty vector lentivirus was also injected into single-cell mouse embryos as a control. The mice were screened by examining expression of CREBH and green fluorescence protein (GFP), a marker for expression from the lentiviral vector. CREBH siRNA specifically targeted and degraded CREBH mRNA in the livers of the knockdown mice (FIG. 7A). Histopathological analysis of the CREBH knockdown embryos at E14.5 did not reveal any morphological or developmental defects (FIG. 7B).

To identify potential target genes for CREBH action in the liver, microarray gene chip analysis of RNA samples from E14.5 control or CREBH knockdown fetal livers was performed. At this time in embryogenesis, the CREBH gene is highly expressed (FIG. 1C). Expression of more than 40 genes was found to be reduced in CREBH knockdown fetal livers (FIG. 3). Through Northern blot and quantitative real-time RT-PCR analyses confirmed that expression of mRNA encoding CRP and its structural homologue pentraxin, SAP, was significantly reduced in the fetal livers of the CREBH knockdown mice compared to the RNAi control transgenic mice (FIG. 8C). In addition, induction of mRNA encoding serum amyloid A3 (SAA3) and apolipoprotein B (ApoB) was reduced 3-5 fold in the CREBH knockdown mice compared to that of the RNAi control mice (FIG. 6A). By comparison, mRNA levels of other major APR proteins including serum amyloid A 1 (SAA1), serum amyloid A2 (SAA2), fibrinogen and α1-acid glycoprotein in CREBH knockdown mice were similar to those in the control mice (FIG. 6B). These data suggest that CREBH is required for the expression of a subset of the APR proteins including CRP, SAP and SAA3 and the lipoprotein ApoB in the developing liver.

CRP is the major component of the APR in humans, whereas it is a minor one in the mouse. In contrast, SAP is the major component of the APR in the mouse, but is a minor one in humans (Bodmer and Siboo, 1977; Le et al., 1982). In mice, both SAP and CRP are inducible by stimulation with pro-inflammatory cytokines or bacterial LPS (Ochrietor et al., 2000). The reduced mRNA levels of CRP and SAP in CREBH knockdown mice suggested that CREBH might be required to activate the APR. To test this hypothesis, the response of CREBH knockdown mice to stimuli of inflammatory cytokines (IL6 plus IL1β), LPS or Tm, respectively was examined. The basal serum levels of SAP and CRP in the CREBH knockdown mice were detectable, but lower than those in control RNAi mice (FIGS. 7D and E), consistent with the Northern blot analysis of mRNA from the fetal livers (FIG. 7C). At 24 hours after injection of IL6 plus IL1β or injection of LPS, serum levels of SAP in the control RNAi mice were significantly increased, to a level of approximately 4.5- or 9-times that of the untreated control mice, respectively (FIG. 7D). In contrast, serum levels of SAP in the CREBH knockdown mice were only slightly increased after IL6 or IL1β or LPS challenge (FIG. 7D). Furthermore, injection of TM increased serum levels of SAP in the control mice approximately 12-fold whereas Tm injection increased serum SAP in the CREBH knockdown mice approximately 2-fold (FIG. 7D). Additionally, while injection of pro-inflammatory cytokines, LPS or Tm increased serum levels of CRP approximately 2-fold in control RNAi mice, there was no such increase in the treated CREBH knockdown mice (FIG. 7E). In addition, although expression of the SAA3 mRNA in the CREBH knockdown fetal liver was defective, induction of serum SAA3 was not significantly reduced in the CREBH knockdown mice in response to those stimuli (data not shown), suggesting that induction of not all APR genes requires CREBH during the APR. Together these in vivo data support the hypothesis that CREBH is required for transcriptional activation of the SAP and CRP genes in response to ER stress as well as pro-inflammatory cytokines in vivo.

ER Stress Simultaneously Activates the UPR and the APR and Inflammatory Cytokines Induce ER Stress and Cleavage of CREBH in the Liver

The finding that cleavage of CREBH is induced by ER stress to activate expression of the APR genes raised the question of whether ER stress induces both the UPR and the APR in hepatocytes. To test this hypothesis, the effect of ER stress on expression of CRP and SAP in mouse primary hepatocytes was examined by Northern blot analysis. Indeed, Tm treatment increased expression of the CRP and SAP mRNA in a time-dependent manner (FIG. 9A). This pattern of induction was similar to that observed for UPR-mediated induction of BiP mRNA and spliced XBP1 mRNA, the product of IRE1-dependent non-conventional splicing (Kaufman, 2002). Furthermore, intraperitoneal injection of Tm induced expression of both the APR genes and the UPR genes in the livers of mice (FIG. 9B). In addition, expression of a mutant human clotting factor VIII (FVIII), a secreted protein that is folding defective (Miao et al., 2004), simultaneously induced the UPR and APR in the mouse liver (FIG. 8A). Together, these data support that ER stress induces both the UPR and the APR in hepatocytes.

Analysis of hepatoma cells in vitro demonstrated that CREBH is cleaved in response to ER stress, but not in response to pro-inflammatory cytokines (FIG. 3B). To provide insight into how CREBH is activated in response to pro-inflammatory cytokines in vivo, studies presented herein investigated whether IL6, IL1β or LPS cause ER stress and activate the UPR in the liver. At 24 hours after injection of IL6, IL1β or LPS, the levels of mRNA encoding ER chaperones GRP78/BiP and GADD153/CHOP were increased 4- to 7-fold in the liver (FIGS. 9C and D). Moreover, the levels of spliced XBP1 mRNA and mRNA encoding EDEM, an ER degradation-enhancing alpha-mannosidase-like protein that is regulated by the UPR (Yoshida et al., 2003), were also increased in the liver upon IL6, IL1β or LPS stimulation (FIGS. 9C and D). The fold increases in these mRNA levels were approximately 50% of those observed after injection of Tm (FIG. 9E). Interestingly, in response to pro-inflammatory cytokines, LPS or Tm, the fold increases in the SAP and CRP mRNA levels correlated with those of the BiP and CHOP mRNA levels in the liver (FIG. 9 C-E). These data suggest that pro-inflammatory cytokines and bacterial LPS can cause, at least indirectly, UPR activation in the liver.

To test whether pro-inflammatory cytokines and LPS can induce cleavage of CREBH during the APR activation, Western blot analysis was performed on mouse liver extracts from wild-type or CREBH knockdown mice challenged with IL6 plus Il1β, LPS or Tm by using an anti-mouse CREBH antibody. Upon stimulation of pro-inflammatory cytokines, LPS or ER stress, the cleaved form of CREBH was increased in the livers of wild-type mice (FIG. 9F). In contrast, CREBH protein was not detected in the livers of CREBH knockdown mice upon the same stimulation (FIG. 13G). These results provide evidence that pro-inflammatory cytokines and LPS induce cleavage of CREBH upon activation of acute inflammatory response in the liver. To clarify why pro-inflammatory cytokines have different effects on CREBH cleavage in hepatoma cells and in the liver, the roles of pro-inflammatory cytokines and LPS in causing ER stress and activation of the UPR and APR were examined in hepatoma cells in vitro. The mRNA levels of BiP, CHOP, EDEM or spliced XBP1 were only marginally changed in murine hepatoma cells treated with LPS or IL6 plus IL1β, indicating that pro-inflammatory cytokines and LPS hardly induce the UPR in hepatoma cells (Supplemental FIG. 7B). Furthermore, the SAP and CRP mRNAs were not detectable in hepatoma cell lines including H2.35 and HepG2, even after treatment of pro-inflammatory cytokines (FIG. 8C). Those results suggest that the acute inflammatory response in hepatoma cell lines is impaired and not comparable to that in the liver.

CREBH Interacts with ATF6 to Synergistically Activate Transcription of Major APR Genes

To determine whether CREBH directly activates transcription from the SAP and CRP promoters, luciferase reporter constructs under control of an 863 bp 5′-flanking sequence from the murine SAP gene or a 637 bp 5′-flanking sequence from the human CRP gene, respectively, were constructed. Expression of full-length CREBH in H2.35 cells increased expression of luciferase from the mouse SAP reporter by approximately 2.5-fold relative to a vector control (FIG. 11A). This increase may reflect ER stress caused by over-expression of CREBH in the transfected cells as described previously (FIGS. 5B and E). Tm treatment further enhanced expression of luciferase from the SAP reporter to a level approximately 14-fold greater than that of the vector control, suggesting that CREBH cleavage upon ER stress has much greater effect on trans-activation of the mouse SAP promoter. Similarly, expression of CREBH significantly activated expression of luciferase under control of the human CRP promoter (FIG. 11A). Furthermore, expression of the nuclear form of CREBH dramatically increased expression of luciferase from both the SAP and CRP reporters by approximately 16 and 11-fold, respectively, compared to the controls (FIG. 11A). These results support the hypothesis that CREBH is cleaved and activated to induce expression of the major acute phase genes upon ER stress.

Many members of the CREB/ATF family, such as CREB, ATF-1 and CREM, form homodimers or heterodimers and bind to the cAMP-responsive element (Shaywitz and Greenberg, 1999). Since CREBH and ATF6 possess highly related bZIP dimerization domains and are both cleaved by the same proteases upon ER stress, it was proposed that CREBH and ATF6 form homodimers or heterodimers to activate transcription of their target genes in response to ER stress. To test this hypothesis, the effect of expression of a truncated CREBH protein that encompasses only the bZIP domain but lacks the transcriptional activation domain (CREBH-DN) was studied. If CREBH activity requires homo- or hetero-dimerization via bZIP domain interactions, then CREBH-DN will dimerize with full-length or cleaved CREBH, and should prevent CREBH-mediated trans-activation of target genes. A vector that expresses CREBH-DN was co-transfected with the human CRP or murine SAP reporter constructs into H2.35 cells. Over-expression of CREBH-DN efficiently suppressed luciferase expression from the human CRP promoter and the murine SAP promoter in response to ER stress (FIG. 11B). This result suggests that CREBH-DN serves as a trans-dominant negative factor that suppresses the action of endogenous CREBH on expression of the SAP and CRP genes.

To directly evaluate the potential for CREBH and ATF6 to form heterodimers, immunoprecipitation (IP)-Western blot analysis was performed on cells that express flag-tagged CREBH protein. IP was performed using an anti-human ATF6 antibody to pull-down endogenous ATF6 protein and Western blot analysis was performed using an anti-flag antibody to detect CREBH protein associated with ATF6. Under normal conditions, a small amount of CREBH was detected in a complex with endogenous ATF6 (FIG. 11C, lane 3). At 8 hours after Tm treatment, the interaction between CREBH and ATF6 significantly increased (FIG. 11C, lane 4). Importantly, the CREBH protein that interacted with ATF6 was the cleaved 50 kD nuclear form. Immunoprecipitation of the same cell lysates using an anti-flag antibody and Western blot analysis using an anti-ATF6 antibody further confirmed interaction between the cleaved ATF6 and CREBH upon Tm treatment (FIG. 11C, lane 4). Together, these results suggest that ER stress induces the formation of CREBH and ATF6 heterodimers.

To investigate the biological significance of CREBH and ATF6 heterodimer formation, it was tested whether CREBH and ATF6 act synergistically to activate transcription from the human CRP and murine SAP promoters. First, it was found that the cleaved form of ATF6 (ATF6 p50) increased expression of luciferase under control of either the human CRP promoter or the murine SAP promoter, although the increase was much smaller than that observed by expression of CREBH (FIG. 11D). Furthermore plasmid DNA encoding the nuclear form of ATF6 (ATF6 p50) or nuclear form of CRBH (CREBH-N) was introduced into wild-type mice through tail vein injection (Miao et al., 2004), and then examined induction of the mouse SAP mRNA in the liver expressing ATF6 p50 or CREBH-N at 36 hours after injection. The liver of mice injected with vector expressing ATF6 p50 or CREBH-N produced higher levels of the murine SAP mRNA compared to the liver of mice injected with control vector, thus confirming activation effects of ATF6 and CREBH on transcription from the endogenous SAP gene in vivo (FIG. 10A). To test whether CREBH and ATF6 act synergistically to activate transcription, it was first determined what the optimal DNA concentrations of the CREBH- and ATF6-expression vectors that should be used to detect a synergistic effect. For co-transfection of H2.35 cells, approximately one-third of the amount of CREBH and ATF6 constructs that maximally activate reporter gene expression was used. In the absence or presence of Tm treatment, expression of CREBH or ATF6 induced transcription from the murine SAP promoter or the human CRP reporter (FIGS. 11E and F), consistent with the earlier results (FIGS. 11A and D). Co-expression of CREBH with ATF6 p50 significantly activated transcription of luciferase from the two reporters to a greater extent than expression of either CREBH or ATF6 p50 alone (FIGS. 11E and F). The synergistic effects of CREBH and ATF6 on transcription from the human CRP promoter and the UPRE were further confirmed by co-expression of the cleaved forms of CREBH and ATF6 (FIGS. 10B and C). Moreover, co-expression of CREBH-DN with either full-length or the cleaved form of CREBH significantly suppressed the ability for CREBH to induce reporter gene expression in the absence or presence of ER stress (FIGS. 11E and F and FIGS. 10B and C). Importantly, co-expression of CREBH-DN with ATF6 p50 efficiently suppressed ATF6-mediated trans-activation on the SAP reporter, the CRP reporter and the UPRE reporter in the absence or presence of ER stress (FIGS. 11E and F and FIGS. 10B and C). The sum of these results suggests that CREBH and ATF6 interact with each other to synergistically activate expression of their target genes in hepatocytes upon ER stress.

CREBH and ATF6 Bind to a Conserved DNA Sequence motif Identified in APR Genes

Binding to a specific DNA sequence to activate transcription of target genes is a characteristic of CREB/ATF transcription factors. The trans-activation effects of CREBH and ATF6 on APR promoters suggest that specific binding sequences for CREBH and ATF6 may exist in the promoter regions of the target genes. Accordingly, searches were conducted for protein binding sequences in the 5′-flanking regions of APR genes. The promoter regions of the mammalian CRP, SAP and ApoB genes were found to contain one or several conserved sequences, having the core nucleotides for CREB/ATF (CRE) and ATF6 (UPRE) binding elements (FIG. 13A). To test whether CREBH and/or ATF6 can bind to this conserved DNA sequence element, electrophoretic mobility shift assay (EMSA) was performed by using nuclear extract (NE) from COS1 cells over-expressing CREBH or ATF6 and a 26 bp biotin-labeled human CRP gene probe containing the conserved DNA sequence. Binding activity was detected with NE from COS1 cells expressing CREBH-F in the absence of Tm (FIG. 13B, lane 2). This weak binding activity was probably due to the nuclear form of CREBH generated by over-expression of full-length CREBH. Tm treatment further increased the binding activity in NE from COS1 cells expressing CREBH-F (FIG. 13B, lane 3). The binding activity to the human CRP probe was significantly increased in NE from COS1 cells over-expressing CREBH-N (FIG. 13B, lane 4), and this binding activity was competed out by adding a 200-fold excess of unlabeled human CRP DNA probe (FIG. 13B, lane 5). Moreover, CREBH-N did not bind to a human CRP probe with mutation at the conserved sequence (FIG. 13B, lane 6). To compare binding activity of full-length CREBH to the human CRP DNA probe with that of the nuclear/cleaved form of CREBH, membrane and nuclear extract protein fractions were prepared from the transfected COS1 cells for EMSA analysis (FIGS. 12A and B). As confirmed by Western blot analysis, the membrane protein fraction from the COS1 cells over-expressing full-length CREBH contained abundant ER membrane-resident full-length CREBH protein, and the nuclear protein extract contained the nuclear/cleaved form of CREBH protein (FIG. 12B). The EMSA results indicate that only the nuclear/cleaved form of CREBH can efficiently bind to the human CRP probe (FIG. 12A), thus providing evidence that cleaved, not full-length, CREBH is required to activate transcription of the specific APR genes. Furthermore, to confirm specific binding of CREBH to the human CRP probe, a DNA-Protein binding assay was performed by using streptavidin-coated beads to bind the biotinylated DNA probe, which was used to interact with NE proteins. Specific proteins bound to the beads were eluted and identified by Western blot analysis (Zhu et al., 2002). Binding reactions were performed with NE from COS1 cells expressing flag-tagged CREBH-N or HA-tagged ATF6 p50. CREBH or ATF6 was detected in the NE proteins that interacted with the wild-type human CRP probe, but not its mutant form (FIG. 13C, lanes 3, 4, 13 and 14). Both CREBH and ATF6 were detected in the DNA probe-interacting NE proteins from cells expressing both CREBH-N and ATF6 p50 (FIG. 13C, lanes 7 and 15). These results confirmed that both CREBH and ATF6 specifically bound to the same conserved element in the human CRP gene. Together with the IP-Western assay showing that the nuclear forms of CREBH and ATF6 can form hetero-dimers upon ER stress (FIG. 11C), the EMSA and DNA-Protein binding assays suggest that CREBH can form hetero-dimers with ATF6 to bind to the proposed CREBH/ATF6-binding element in the APR genes.

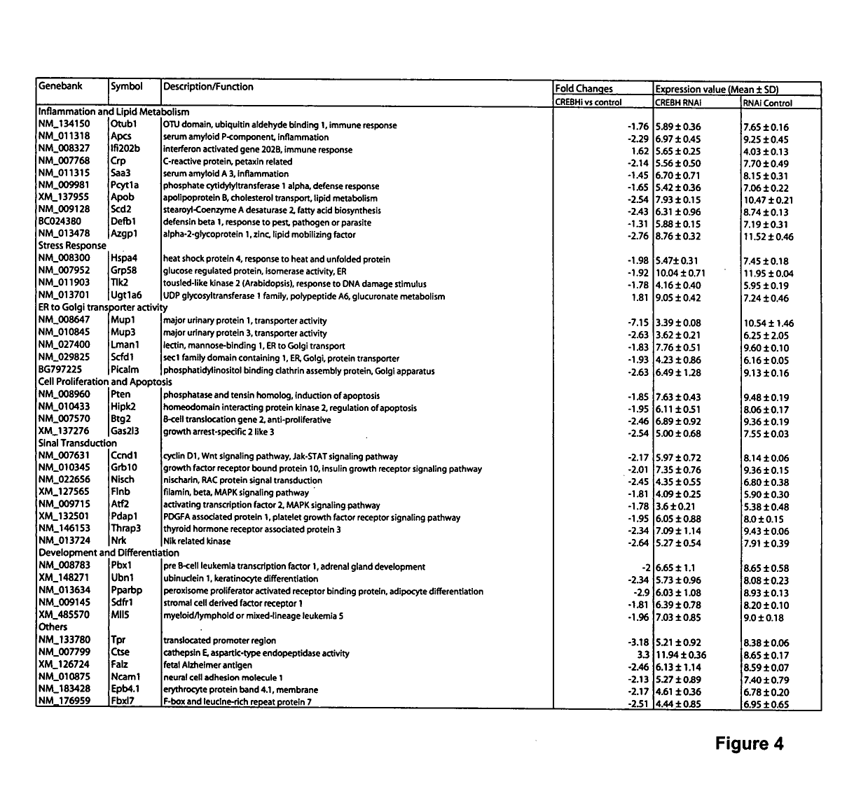

ApoB, the essential component of very low-density lipoprotein (VLDL) and low-density lipoprotein (LDL), is associated with acute phase response to inflammation (Sattar et al., 2004). Induction of the ApoB mRNA in the CREBH knockdown fetal liver was significantly decreased compared to that in the control mice (FIGS. 4 and 6A). The nuclear form of CREBH was found to significantly activate transcription of luciferase under control of a 901 bp promoter sequence from the human ApoB gene (FIG. 12C). Furthermore, both the human and murine ApoB genes contain one or several proposed CREBH/ATF6-binding elements in their promoter regions (FIG. 13A). EMSA assay demonstrated that the nuclear forms of CREBH and ATF6 bind to at least one of the CREBH/ATF6-binding elements in the human ApoB gene (FIG. 12D). However, in contrast to CRP and SAP, induction of endogenous ApoB mRNA in mice was only slightly increased in response to Tm treatment (FIG. 12E), suggesting that ER stress-induced activation of CREBH may be required for, but not sufficient to fully activate transcription of the ApoB gene during the APR. Whether other factors are required to function with CREBH to induce transcription of the ApoB gene during acute phase response is an intriguing question to be elucidated.

### REFERENCES

All publications including the list of the following, which are referenced in the foregoing specification, are hereby incorporated by reference in their entirety. In case of any conflict between the teachings of the instant references and the specification, the specification shall control.
Abel, T., Bhatt, R., and Maniatis, T. (1992). A Drosophila CRAB/ATF Transcriptional activator binds to both fat body- and liver-specific regulatory elements. Gene Dev. 6, 466-480.
Agrawal, A., Cha-Molstad, H., Samols, D., and Kushner, I. (2001). Transactivation of C-reactive protein by IL-6 requires synergistic interaction of CCAAT/enhancer binding protein beta (C/EBP beta) and Rel p50. J Immunol 166, 2378-2384.
Back, S. H., Schroder, M., Lee, K., Zhang, K., and Kaufman, R. J. (2005). ER stress signaling by regulated splicing: IRE1/HAC1/XBP1. Methods 35, 395-416.
Bi L, Lawler A M; Antonarakis S E, High K A, Gearhart J D, Kazazian H H, Jr. (1995) Targeted disruption of the mouse factor VIII gene produces a model of haemophilia A. Nature Genetics 10: 119-121.
Black, S., Kushner, I., and Samols, D. (2004). C-reactive Protein. J Biol Chem 279, 48487-48490.
Bo, S., Gambino, R., Uberti, B., Mangiameli, M. P., Colosso, G., Repetti, E., Gentile, L., Cassader, M., and Pagano, G. F. (2005). Does C— reactive protein identify a subclinical metabolic disease in healthy subjects? Eur J Clin Invest 35, 265-270.
Bodmer, B., and Siboo, R. (1977). Isolation of mouse C-reactive protein from liver and serum. J Immunol 118, 1086-1089.
Brown, M. S., and Goldstein, J. L. (1997). The SREBP pathway: regulation of cholesterol metabolism by proteolysis of a membrane-bound transcription factor. Cell 89, 331-340.
Brown, M. S., Ye, J., Rawson, R. B., and Goldstein, J. L. (2000). Regulated intramembrane proteolysis: a control mechanism conserved from bacteria to humans. Cell 100, 391-398.
Cha-Molstad, H., Agrawal, A., Zhang, D., Samols, D., and Kushner, I. (2000). The Rel family member P50 mediates cytokine-induced C-reactive protein expression by a novel mechanism. J Immunol 165, 4592-4597.
Cheng, D., Espenshade, P. J., Slaughter, C. A., Jaen, J. C., Brown, M. S., and Goldstein, J. L. (1999). Secreted site-1 protease cleaves peptides corresponding to luminal loop of sterol regulatory element-binding proteins. J Biol Chem 274, 22805-22812.
Chin, K. T., Zhou, H. J., Wong, C. M., Lee, J. M., Chan, C. P., Qiang, B. Q., Yuan, J. G., Ng, I. O., and Jin, D. Y. (2005). The liver-enriched transcription factor CREB-H is a growth suppressor protein underexpressed in hepatocellular carcinoma. Nucleic Acids Res 33, 1859-1873.
Danenberg, H. D., Szalai, A. J., Swaminathan, R. V., Peng, L., Chen, Z., Seifert, P., Fay, W. P., Simon, D. I., and Edelman, E. R. (2003). Increased thrombosis after arterial injury in human C-reactive protein-transgenic mice. Circulation 108, 512-515.
Danesh, J., Wheeler, J. G., Hirschfield, G. M., Eda, S., Eiriksdottir, G., Rumley, A., Lowe, G. D., Pepys, M. B., and Gudnason, V. (2004). C-reactive protein and other circulating markers of inflammation in the prediction of coronary heart disease. N Engl J Med 350, 1387-1397.
DeBose-Boyd, R. A., Brown, M. S., Li, W. P., Nohturfft, A., Goldstein, J. L., and Espenshade, P. J. (1999). Transport-dependent proteolysis of SREBP: relocation of site-1 protease from Golgi to ER obviates the need for SREBP transport to Golgi. Cell 99, 703-712.
Dignam J D, Martin P L, Shastry B S, Roeder-R G (1983) Eukaryotic gene transcription with purified components. Methods Enzymol 101: 582-98.
Dorner A J, Bole D G, Kaufman R J (1987) The relationship of N-linked glycosylation and heavy chain-binding protein association with the secretion of glycoproteins. J Cell Biol 105: 2665-2674.
Dorner A J, Wasley L C, Kaufman R J (1989) Increased synthesis of secreted proteins induces expression of glucose regulated proteins in butyrate treated CHO cells. Journal of Biological Chemistry 264: 20602-20607.
Feng, B., Yao, P. M., Li, Y., Devlin, C. M., Zhang, D., Harding, H. P., Sweeney, M., Rong, J. X., Kuriakose, G., Fisher, E. A., et al. (2003). The endoplasmic reticulum is the site of cholesterol-induced cytotoxicity in macrophages. Nat Cell Biol 5, 781-792.
Feramisco, J. D., Radhakrishnan, A., Ikeda, Y., Reitz, J., Brown, M. S., and Goldstein, J. L. (2005). Intramembrane aspartic acid in SCAP protein governs cholesterol-induced conformational change. Proc Natl Acad Sci USA 102, 3242-3247.
Fisher, E. A., and Ginsberg, H. N. (2002). Complexity in the secretory pathway: the assembly and secretion of apolipoprotein B-containing lipoproteins. J Biol Chem 277, 177377-17380.
Gabay, C., and Kushner, I. (1999). Acute-phase proteins and other systemic responses to inflammation. N Engl J Med 340, 448-454.
Hansson, G. K. (2005). Inflammation, atherosclerosis, and coronary artery disease. N Engl J Med 352, 1685-1695.
Harding, H. P., Calfon, M., Urano, F., Novoa, I., and Ron, D. (2002). Transcriptional and translational control in the Mammalian unfolded protein response. Annu Rev Cell Dev Biol 18, 575-599.
Hasan, M. T., Chang, C. C., and Chang, T. Y. (1994). Somatic cell genetic and biochemical characterization of cell lines resulting from human genomic DNA transfections of Chinese hamster ovary cell mutants defective in sterol-dependent activation of sterol synthesis and LDL receptor expression. Somat Cell Mol Genet 20, 183-194.
Haze, K., Yoshida, H., Yanagi, H., Yura, T., and Mori, K. (1999). Mammalian transcription factor ATF6 is synthesized as a transmembrane protein and activated by proteolysis in response to endoplasmic reticulum stress. Mol Biol Cell 10, 3787-3799.
Hughes, A. L., Todd, B. L., and Espenshade, P. J. (2005). SREBP pathway responds to sterols and functions as an oxygen sensor in fission yeast. Cell 120, 831-842.
Kadowaki, N., Ho, S., Antonenko, S., Malefyt, R. W., Kastelein, R. A., Bazan, F., and Liu, Y. J. (2001). Subsets of human dendritic cell precursors express different toll-like receptors and respond to different microbial antigens. J Exp Med 194, 863-869.
Kaufman, R. J. (1999). Stress signaling from the lumen of the endoplasmic reticulum: coordination of gene transcriptional and translational controls. Genes Dev 13, 1211-1233.
Kaufman, R. J. (2002). Orchestrating the unfolded protein response in health and disease. J Clin Invest 110, 1389-1398.
Khovidhunkit, W., Memon, R. A., Feingold, K. R., and Grunfeld, C. (2000). Infection and inflammation-induced proatherogenic changes of lipoproteins. J Infect Dis 181 Suppl 3, S462-472.
Kondo, S., Murakami, T., Tatsumi, K., Ogata, M., Kanemoto, S., Otori, K., Iseki, K., Wanaka, A., and Imaizumi, K. (2005). OASIS, a CREB/ATF-family member, modulates UPR signalling in astrocytes. Nat Cell Biol 7, 186-194.
Kushner, I. (1982). The phenomenon of the acute phase response. Ann N Y Acad Sci 389, 39-48.
Kushner, I., and Kaplan, M. H. (1961). Studies of acute phase protein. I. An immunohistochemical method for the localization of Cx-reactive protein in rabbits. Association with necrosis in local inflammatory lesions. J Exp Med 114, 961-974.
Le, P. T., Muller, M. T., and Mortensen, R. F. (1982). Acute phase reactants of mice. Isolation of serum amyloid P-component (SAP) and its induction by a monokine. J Immunol 129, 665-672.
Lee, A. H., Iwakoshi, N. N., and Glimcher, L. H. (2003). XBP-1 regulates a subset of endoplasmic reticulum resident chaperone genes in the unfolded protein response. Mol Cell Biol 23, 7448-7459.
Lee, K., Tirasophon, W., Shen, X., Michalak, M., Prywes, R., Okada, T., Yoshida, H., Mori, K., and Kaufman, R. J. (2002). IRE1-mediated unconventional mRNA splicing and S2P-mediated ATF6 cleavage merge to regulate XBP1 in signaling the unfolded protein response. Genes Dev 16, 452-466.
Macintyre, S., Samols, D., and Dailey, P. (1994). Two carboxylesterases bind C-reactive protein within the endoplasmic reticulum and regulate its secretion during the acute phase response. J Biol Chem 269, 24496-24503.
Macintyre, S. S. (1992). Regulated export of a secretory protein from the ER of the hepatocyte: a specific binding site retaining C-reactive protein within the ER is downregulated during the acute phase response. J Cell Biol 118, 253-265.
Mackey, S. L., and Darlington, G. J. (2004). CCAAT enhancer-binding protein alpha is required for interleukin-6 receptor alpha signaling in newborn hepatocytes. J Biol Chem 279, 16206-16213.
Majello, B., Arcone, R., Toniatti, C., and Ciliberto, G. (1990). Constitutive and IL-6-induced nuclear factors that interact with the human C-reactive protein promoter. Embo J 9, 457-465.
Matsuda, M., Korn, B. S., Hammer, R. E., Moon, Y. A., Komuro, R., Horton, J. D., Goldstein, J. L., Brown, M. S., and Shimomura, I. (2001). SREBP cleavage-activating protein (SCAP) is required for increased lipid synthesis in liver induced by cholesterol deprivation and insulin elevation. Genes Dev 15, 1206-1216.
Medzhitov, R., and Janeway, C. A., Jr. (2002). Decoding the patterns of self and nonself by the innate immune system. Science 296, 298-300.
Medzhitov, R., Preston-Hurlburt, P., and Janeway, C. A., Jr. (1997). A human homologue of the Drosophila Toll protein signals activation of adaptive immunity. Nature 388, 394-397.
Miao, H. Z., Sirachainan, N., Palmer, L., Kucab, P., Cunningham, M. A., Kaufman, R. J., and Pipe, S. W. (2004). Bioengineering of coagulation factor VIII for improved secretion. Blood 103, 3412-3419.
Mori, K. (2000). Tripartite management of unfolded proteins in the endoplasmic reticulum. Cell 101, 451-454.
Nadanaka, S., Yoshida, H., Kano, F., Murata, M., and Mori, K. (2004). Activation of mammalian unfolded protein response is compatible with the quality control system operating in the endoplasmic reticulum. Mol Biol Cell 15, 2537-2548.
Nissen, S. E., Tuzcu, E. M., Schoenhagen, P., Crowe, T., Sasiela, W. J., Tsai, J., Orazem, J., Magorien, R. D., O'Shaughnessy, C., and Ganz, P. (2005). Statin therapy, LDL cholesterol, C-reactive protein, and coronary artery disease. N Engl J Med 352, 29-38.
Ochrietor, J. D., Harrison, K. A., Zahedi, K., and Mortensen, R. F. (2000). Role of STAT3 and C/EBP in cytokine-dependent expression of the mouse serum amyloid P-component (SAP) and C-reactive protein (CRP) genes. Cytokine 12, 888-899.
Okada, T., Yoshida, H., Akazawa, R., Negishi, M., and Mori, K. (2002). Distinct Roles of ATF6 and PERK in Transcription during the Mammalian Unfolded Protein Response. Biochem J 16.
Omori, Y., Imai, J., Watanabe, M., Komatsu, T., Suzuki, Y., Kataoka, K., Watanabe, S., Tanigami, A., and Sugano, S. (2001). CREB-H: a novel mammalian transcription factor belonging to the CREB/ATF family and functioning via the box-B element with a liver-specific expression. Nucleic Acids Res 29, 2154-2162.
Pahl, H. L. (1999). Signal transduction from the endoplasmic reticulum to the cell nucleus. Physiol Rev 79, 683-701.
Paterson H, Adamson P, Robertson D (1995) Microinjection of epitope-tagged Rho family cDNAs and analysis by immunolabeling. Methods Enzymol. 256: 162-173
Paul, A., Ko, K. W., Li, L., Yechoor, V., McCrory, M. A., Szalai, A. J., and Chan, L. (2004). C-reactive protein accelerates the progression of atherosclerosis in apolipoprotein E-deficient mice. Circulation 109, 647-655.
Raggo, C., Rapin, N., Stirling, J., Gobeil, P., Smith-Windsor, E., O'Hare, P., and Misra, V. (2002). Luman, the cellular counterpart of herpes simplex virus VP16, is processed by regulated intramembrane proteolysis. Mol Cell Biol 22, 5639-5649.
Rawson, R. B., Zelenski, N. G., Nijhawan, D., Ye, J., Sakai, J., Hasan, M. T., Chang, T. Y., Brown, M. S., and Goldstein, J. L. (1997). Complementation cloning of S2P, a gene encoding a putative metalloprotease required for intramembrane cleavage of SREBPs. Mol Cell 1, 47-57.
Ridker, P. M., Cannon, C. P., Morrow, D., Rifai, N., Rose, L. M., McCabe, C. H., Pfeffer, M. A., and Braunwald, E. (2005). C-reactive protein levels and outcomes after statin therapy. N Engl J Med 352, 20-28.
Ridker, P. M., Wilson, P. W., and Grundy, S. M. (2004). Should C-reactive protein be added to metabolic syndrome and to assessment of global cardiovascular risk? Circulation 109, 2818-2825.
Rubinson, D. A., Dillon, C. P., Kwiatkowski, A. V., Sievers, C., Yang, L., Kopinja, J., Rooney, D. L., Ihrig, M. M., McManus, M. T., Gertler, F. B., et al. (2003). A lentivirus-based system to functionally silence genes in primary mammalian cells, stem cells and transgenic mice by RNA interference. Nat Genet 33, 401-406.
Sakai, J., Duncan, E. A., Rawson, R. B., Hua, X., Brown, M. S., and Goldstein, J. L. (1996). Sterol-regulated release of SREBP-2 from cell membranes requires two sequential cleavages, one within a transmembrane segment. Cell 85, 1037-1046.
Sakai, J., Nohturfft, A., Goldstein, J. L., and Brown, M. S. (1998a). Cleavage of sterol regulatory element-binding proteins (SREBPs) at site-1 requires interaction with SREBP cleavage-activating protein. Evidence from in vivo competition studies. J Biol Chem 273, 5785-5793.
Sakai, J., Rawson, R. B., Espenshade, P. J., Cheng, D., Seegmiller, A. C., Goldstein, J. L., and Brown, M. S. (1998b). Molecular identification of the sterol-regulated luminal protease that cleaves SREBPs and controls lipid composition of animal cells. Mol Cell 2, 505-514.
Sambrook, J., Fritsch E F, Maniatis T (1989) Molecular Cloning: A Laboratory Manual, 2 edn. Cold Spring Harbor Laboratory, New York
Sattar, N., Williams, K., Sniderman, A. D., D'Agostino, R., Jr., and Haffner, S. M. (2004). Comparison of the associations of apolipoprotein B and non-high-density lipoprotein cholesterol with other cardiovascular risk factors in patients with the metabolic syndrome in the Insulin Resistance Atherosclerosis Study. Circulation 110, 2687-2693.
Schroder, M. and Kaufman, R. J. (2005). The mammalian unfolded protein response. Annu Rev Biochem 74:739-789.
Shaywitz, A. J., and Greenberg, M. E. (1999). CREB: a stimulus-induced transcription factor activated by a diverse array of extracellular signals. Annu Rev Biochem 68, 821-861.
Shen, J., Chen, X., Hendershot, L., and Prywes, R. (2002). ER stress regulation of ATF6 localization by dissociation of BiP/GRP78 binding and unmasking of Golgi localization signals. Dev Cell 3, 99-111.
Shen, X., Ellis, R. E., Sakaki, K., and Kaufman, R. J. (2005). Genetic interactions due to constitutive and inducible gene regulation mediated by the unfolded protein response in C. elegans. Plos Genetics (in press).
Sidrauski, C., Chapman, R., and Walter, P. (1998). The unfolded protein response: an intracellular signalling pathway with many surprising features. Trends Cell Biol 8, 245-249.
Sifers, R. N., Brashears-Macatee, S., Kidd, V. J., Muensch, H., and Woo, S. L. (1988). A frameshift mutation results in a truncated alpha 1-antitrypsin that is retained within the rough endoplasmic reticulum. J Biol Chem 263, 7330-7335.
Tardif, K. D., Waris, G., and Siddiqui, A. (2005). Hepatitis C virus, ER stress, and oxidative stress. Trends Microbiol 13, 159-163.
Tirasophon W, Welihinda A A, Kaufman R J (1998) A stress response pathway from the endoplasmic reticulum to the nucleus requires a novel bifunctional protein inase/endoribonuclease (Irelp) in mammalian cells. Genes. Dev. 12: 1812-1824.
Toure, B. B., Munzer, J. S., Basak, A., Benjannet, S., Rochemont, J., Lazure, C., Chretien, M., and Seidah, N. G. (2000). Biosynthesis and enzymatic characterization of human SKI-1/S1P and the processing of its inhibitory prosegment. J. Biol Chem 275, 2349-2358.
Wang, Y., Shen, J., Arenzana, N., Tirasophon, W., Kaufman, R. J., and Prywes, R. (2000). Activation of ATF6 and an ATF6 DNA Binding Site by the Endoplasmic Reticulum Stress Response. J Biol Chem 275, 27013-27020.
Yamamoto, K., Yoshida, H., Kokame, K., Kaufman, R. J., and Mori, K. (2004). Differential contributions of ATF6 and XBP1 to the activation of endoplasmic reticulum stress-responsive cis-acting elements ERSE, UPRE and ERSE-II. J Biochem (Tokyo) 136, 343-350.
Yang, T., Espenshade, P. J., Wright, M. E., Yabe, D., Gong, Y., Aebersold, R., Goldstein, J. L., and Brown, M. S. (2002). Crucial step in cholesterol homeostasis: sterols promote binding of SCAP to INSIG-1, a membrane protein that facilitates retention of SREBPs in ER. Cell 110, 489-500.
Ye, J., Dave, U. P., Grishin, N. V., Goldstein, J. L., and Brown, M. S. (2000a). Asparagine-proline sequence within membrane-spanning segment of SREBP triggers intramembrane cleavage by site-2 protease. Proc Natl Acad Sci USA 97, 5123-5128.
Ye, J., Rawson, R. B., Komuro, R., Chen, X., Dave, U. P., Prywes, R., Brown, M. S., and Goldstein, J. L. (2000). ER Stress Induces Cleavage of Membrane-Bound ATF6 by the Same Proteases that Process SREBPs. Mol Cell 6, 1355-1364.
Yoo, J. Y., and Desiderio, S. (2003). Innate and acquired immunity intersect in a global view of the acute-phase response. Proc Natl Acad Sci USA 100, 1157-1162.
Yoshida, H., Haze, K., Yanagi, H., Yura, T., and Mori, K. (1998). Identification of the cis-acting endoplasmic reticulum stress response element responsible for transcriptional induction of mammalian glucose-regulated proteins. Involvement of basic leucine zipper transcription factors. J Biol Chem 273, 33741-33749.
Yoshida, H., Matsui, T., Hosokawa, N., Kaufman, R. J., Nagata, K., and Mori, K. (2003). A time-dependent phase shift in the mammalian unfolded protein response. Dev Cell 4, 265-271.
Yoshida, H., Matsui, T., Yamamoto, A., Okada, T., and Mori, K. (2001). XBP1 mRNA is induced by ATF6 and spliced by IRE1 in response to ER stress to produce a highly active transcription factor. Cell 107, 881-891.
Yue, C. C., Muller-Greven, J., Dailey, P., Lozanski, G., Anderson, V., and Macintyre, S. (1996). Identification of a C-reactive protein binding site in two hepatic carboxylesterases capable of retaining C-reactive protein within the endoplasmic reticulum. J Biol Chem 271, 22245-22250.
Zaret K S, DiPersio C M, Jackson D A, Montigny W J, Weinstat D L (1988) Conditional enhancement of liver-specific gene transcription. Proc Natl Acad Sci USA 85: 9076-80.
Zaret, K. S. (2002). Regulatory phases of early liver development: paradigms of organogenesis. Nat Rev Genet 3, 499-512.
Zhang, C., Cai, Y., Adachi, M. T., Oshiro, S., Aso, T., Kaufman, R. J., and Kitajima, S. (2001). Homocysteine induces programmed cell death in human vascular endothelial cells through activation of the unfolded protein response. J Biol Chem 276, 35867-35874.
Zhang, D., Sun, M., Samols, D., and Kushner, I. (1996). STAT3 participates in transcriptional activation of the C-reactive protein gene by interleukin-6. J Biol Chem 271, 9503-9509.
Zhu, C., Johansen, F. E., and Prywes, R. (1997). Interaction of ATF6 and serum response factor. Mol Cell Biol 17, 4957-4966.
Zhu, Y., Saunders, M. A., Yeh, H., Deng, W. G., and Wu, K. K. (2002). Dynamic regulation of cyclooxygenase-2 promoter activity by isoforms of CCAAT/enhancer-binding proteins. J Biol Chem 277, 6923-6928.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are intended to be embraced therein.

What is claimed is:

1. A method of modulating an acute phase response in a mammal, comprising the step of modulating the expression of CREBH.

2. A method of modulating an acute phase response in a mammal, comprising the step of modulating the post-translational processing of CREBH.

3. The method of claim 2, wherein said post-translational processing comprises cleavage by S1P and/or S2P.

4. A method of modulating an acute phase response in a mammal, comprising the step of modulating the association of a CREBH fragment with ATF6.

5. The method of claim 4, wherein the CREBH fragment is the product of cleavage of CREBH by S1P and/or S2P.

6. A method of modulating an innate immune response in a mammal, comprising the step of modulating the expression and/or post-translational processing of CREBH, and/or of modulating the association of CREBH with ATF6.

7. A method of modulating inflammation in a mammal, comprising the step of modulating the expression and/or post-translational processing of CREBH, and/or of modulating the association of CREBH with ATF6.

8. A method of modulating the level of circulating C-reactive protein in a mammal, comprising the step of modulating the expression and/or post-translational processing of CREBH, and/or of modulating the association of CREBH with ATF6.

9. A method of treating atherosclerosis in a mammal, comprising the step of modulating the expression and/or post-translational processing of CREBH, and/or of modulating the association of CREBH with ATF6.

10. The method of claim 1, 2, 4, 6, 7, 8, or 9, wherein said step of modulating is a step of inhibiting the expression and/or post-translational processing of CREBH, and/or of modulating the association of CREBH with ATF6.

11. A method of assessing whether a mammal is at risk for developing atherosclerosis, comprising the step of assessing the level of CREBH expression, and/or assessing the level of post-translationally modified CREBH, and/or assessing the level of a complex comprising CREBH and ATF6, in said mammal.

12. A method of monitoring treatment of a mammal for atherosclerosis, comprising the step of assessing the level of CREBH expression, and/or assessing the level of post-translationally modified CREBH, and/or assessing the level of a complex comprising CREBH and ATF6, in said mammal.

13. A method of identifying a compound that modulates an acute phase response in a mammal, comprising the steps of:
(a) providing a mammalian cell capable of expressing CREBH;
(b) exposing said cell to an inducer of the acute phase response;
(c) contacting said cell with a candidate compound;
(d) assessing whether CREBH expression in said cell is modulated by exposure to the inducer in the presence of the candidate compound, relative to the expression level thereof in the absence of the candidate compound;
wherein modulation of the expression level of CREBH in the presence of the candidate compound indicates that the compound is a modulator of the acute phase response in said mammal.

14. A method of identifying a compound that modulates an acute phase response in a mammal, comprising the steps of:
(a) providing a mammalian cell capable of producing CREBH;
(b) exposing said cell to an inducer of the acute phase response;
(c) contacting said cell with a candidate compound;
(d) assessing whether post-translational processing of CREBH in said cell is modulated by exposure to the inducer in the presence of the candidate compound, relative to the processing level thereof in the absence of the candidate compound;
wherein modulation of the post-translational processing of CREBH in the presence of the candidate compound indicates that the compound is a modulator of the acute phase response in said mammal.

15. A method of identifying a compound that modulates an acute phase response in a mammal, comprising the steps of:
(a) providing a mammalian cell capable of producing CREBH;
(b) exposing said cell to an inducer of the acute phase response;
(c) contacting said cell with a candidate compound;
(d) assessing whether formation of a complex between CREBH and ATF6 in said cell is modulated by exposure to the inducer in the presence of the candidate compound, relative to the level of said complex in the absence of the candidate compound;
wherein modulation of the formation of the complex in the presence of the candidate compound indicates that the compound is a modulator of the acute phase response in said mammal.

16. The method of claim 13, 14, or 15, wherein the candidate compound is a small molecule.

17. The method of claim 13, 14, or 15, wherein the candidate compound is a member of a combinatorial chemistry library.

18. The method of claim 13, 14, or 15, wherein the candidate compound is a member of a natural product library.

19. The method of claim 13, 14, or 15, wherein the inducer of the acute phase response is a pro-inflammatory cytokine, a drug that induces ER stress, or bacterial LPS.

20. The method of claim 13, 14, or 15, wherein the CREBH is a fusion protein.

21. The method of claim 20, wherein the CREBH is fused to a detectable peptide.

22. A compound identified according to the method of claim 13, 14, or 15.

23. A compound that inhibits expression of CREBH in a mammalian cell exposed to an inducer of the acute phase response.

24. A small interfering RNA compound of claim 23.

25. A vector comprising the small interfering RNA compound of claim 24.

26. A compound that inhibits post-translational processing of CREBH in a mammalian cell exposed to an inducer of the acute phase response.

27. A compound of claim 26 that inhibits cleavage of CREBH by S1P and/or S2P.

28. A compound that inhibits formation of a complex between CREBH and ATF6 in a mammalian cell exposed to an inducer of the acute phase response.

29. A compound of claim 28 that binds to CREBH.

30. A compound of claim 28 that binds to ATF6.

31. A dominant negative CREBH polypeptide of claim 30, consisting of a CREBH bZIP domain.

32. A vector encoding the dominant negative CREBH polypeptide of claim 31.

33. A compound that inhibits the binding of CREBH to nucleic acid comprising an UPRE.

34. A compound of claim 33 that binds to CREBH.

35. A compound of claim 33 that binds to an UPRE nucleic acid sequence.

36. A compound that inhibits the binding of CREBH to nucleic acid encoding a 5′ flanking sequence of the human CRP gene.

37. A compound of claim 36 that binds to CREBH.

38. A compound of claim 36 that binds to said 5′ flanking sequence.
